(19) United States
(12) Patent Application Publication
(10) Pub. No.: US 2025/0186836 A1
(43) Pub. Date: Jun. 12, 2025

(54) GOLF TRACKING SYSTEM FOR MONITORING AND MANAGEMENT OF DATA

(71) Applicant: PGA TOUR Enterprises, LLC, Ponte Vedra Beach, FL (US)

(72) Inventors: Jeremy Craven, Ponte Vedra Beach, FL (US); Troy Cooke, Ponte Vedra Beach, FL (US); Jeff Howell, Ponte Vedra Beach, FL (US); Barry Walker, Ponte Vedra Beach, FL (US); Jonas Gredenhag, Ponte Vedra Beach, FL (US); Scott Ross, Ponte Vedra Beach, FL (US); Nathan Verlin, Ponte Vedra Beach, FL (US); Jason Legler, Ponte Vedra Beach, FL (US); Alexander Grach, Ponte Vedra Beach, FL (US); Marianne Davis, Ponte Vedra Beach, FL (US); Walter Lovell, Ponte Vedra Beach, FL (US)

(73) Assignee: PGA TOUR Enterprises, LLC, Ponte Vedra Beach, FL (US)

(21) Appl. No.: 18/949,970

(22) Filed: Nov. 15, 2024

Related U.S. Application Data
(60) Provisional application No. 63/599,557, filed on Nov. 15, 2023.

(51) Int. Cl. A63B 24/00; A63B 71/06

(52) U.S. Cl. CPC A63B 24/0021; A63B 71/06; A63B 2024/0025; A63B 2024/0028; A63B 2220/10; A63B 2220/80

(57) ABSTRACT

A method of tracking golf play includes receiving a plurality of coordinate sets corresponding to a plurality of shot to locations of golf balls hit by a plurality of players on a hole in a golf event. The plurality of coordinate sets were automatically captured in sensor data of a plurality of sensor device coordinate sources positioned around the hole. Hole events corresponding to strokes of the plurality of players on the hole in the golf event are received that were automatically detected in sensor data of a sensor device hole event sources. Each hole event may be automatically associated with one of the plurality of coordinate sets that correspond to the shot to location of the golf ball for the stroke the hole event corresponds to generate detailed scoring data for the plurality of players on the hole in the golf event.

### CROSS-REFERENCE TO RELATED APPLICATIONS

The present application claims priority to U.S. Provisional Patent Application 63/599,557, filed Nov. 15, 2023, the contents of which is hereby incorporated by reference herein in its entirety.

### TECHNOLOGY

The present application is directed to monitoring and managing data collected by a plurality of sensors positioned around a golf course to support scoring and statistical information for golf events with minimal human interaction.

### SUMMARY

In one aspect, a method of tracking golf play includes receiving a plurality of coordinate sets corresponding to a plurality of shot to locations of golf balls hit by a plurality of players on a hole in a golf event, wherein the plurality of coordinate sets were automatically captured in sensor data of a plurality of sensor device coordinate sources positioned around the hole. The method may further include receiving hole events corresponding to strokes of the plurality of players on the hole in the golf event, wherein the hole events were automatically detected in sensor data of a sensor device hole event sources. The method may further include associating, automatically, each of the hole events with one of the plurality of coordinate sets that correspond to the shot to location of the golf ball for the stroke the hole event corresponds to generate detailed scoring data for the plurality of players on the hole in the golf event.

In one example, the plurality of sensor device coordinate sources may include different types of sensor devices.

In the above or another example, the plurality of sensor device coordinate sources may include at least a radar device, and wherein the plurality of coordinate sets includes coordinate sets corresponding to predicted shot to locations generated by a prediction generator using trajectory data of the corresponding golf ball.

In any combination of the above examples or in a another example, wherein the plurality of sensor device coordinate sources may include one or more radar devices, one or more camera devices, and one or more laser devices.

In any combination of the above examples or in a another example, the hole events may include identification of the player the hole event relates.

In any combination of the above examples or in a another example, each of the plurality of coordinate sets may include associated data elements comprising a timestamp with respect to time the respective golf ball was identified or predicted to at the shot to location.

In any combination of the above examples or in a another example, associating each of the hole events with one of the coordinate sets may include filtering the plurality of coordinate sets to obtain a single coordinate set comprising a “final” shot to coordinate location.

In any combination of the above examples or in a further example, associating each of the hole events with one of the plurality of coordinate sets may include filtering the plurality of coordinate sets by grouping the plurality of coordinates sets by sensor device coordinate source and retaining a coordinate set for each group that is closest in time to the timestamp of the hole event.

In any combination of the above examples or in a further example, associating each of the hole events with one of the plurality of coordinate sets may include executing a candidate coordinate set function on a filtered set of the plurality of coordinate sets to select a single coordinate set for the hole event that corresponds to the shot to location of the golf ball the hole event relates.

In any combination of the above examples or in a further example, the candidate coordinate set function may include hierarchy rules with respect to type of sensor device coordinate source.

In any combination of the above examples or in a further example, associating each of the hole events with one of the plurality of coordinate sets may include applying one or more of a cascading filter wherein the selection of a coordinate set depends on selection or filtering of another coordinate set, a distance related filter to filter out coordinate sets that are within or outside a distance from a tee or cup of the hole, a geographic filter with respect to geographic data elements associated with the hole events and plurality of coordinate sets, a temporal filter with respect to timestamps data elements associated with the hole events and plurality of coordinate set, or a geo-temporal filter the plurality of coordinate sets.

In any combination of the above examples or in a another example, associating each of the hole events with one of the plurality of coordinate sets may include filtering coordinate sets of the plurality of coordinate sets by excluding coordinates that are already associated with a hole event.

In another aspect, a tracking system for tracking golf play includes a sensor network including a plurality of sensors positioned around a hole of a golf course. The plurality of sensors include at least a radar device and a camera device. The radar device may be configured for automated tracking of golf balls in flight after being struck by players on the hole. The camera device may be configured to identify players and track the players as they play the hole. A tracking module may be configured to receive radar data generated by the radar device corresponding to a plurality of tracked golf ball in flight after being hit by the players. The radar data may include timestamps with respect to when the golf balls in flight were tracked and location data at least with respect to an initial ball flight of the tracked golf balls in flight after being struck. The tracking module may be configured to receive camera data generated by the camera device corresponding to the players identified and tracked during the play on the hole. The camera data may include timestamps with respect to location data corresponding to locations of the identified tracked players as they played the hole. The tracking module may be configured to tie the location data corresponding to the locations of the initial ball flights of the tracked balls to the location data corresponding to the locations of the identified tracked players as they played the hole using the respective timestamps to match each of the players to the locations of the initial ball flight of each of their hits when playing the hole.

In any combination of the above examples or in a another example, the tracking module may be configured to automatically generate a hole score for each of the players based on the tracked golf balls in flight matched with the respective identified players.

In yet another aspect, a tracking system for tracking golf play includes a scoring module configured to monitor scoring data with respect to players competing in a golf event that is received into the tracking system. The scoring data may be automatically generated by leveraging sensor data with respect to player and ball locations during play that is collected by automated sensor devices positioned around a golf course hosting the golf event.

The scoring module may include an application executed by the tracking system that may be configured to analyze scoring data, event data, or both stored in a scoring database or event database and identify anomalies in the scoring data, event data, or both.

In one example, the scoring module may be configured to communicate with a tracking module to receive event data triggering notifications to the scoring module with respect to player, ball, or object anomalies.

In one example, the scoring module may be configured to communicate with a prediction generator, coordinate processor, or both to receive notifications with respect to capturing coordinates.

In any combination of the above examples or in a another example, the scoring module may be configured to provide a notification of an anomaly to electronic communication devices for users of the electronic communication devices to take action and address the anomaly or obtain a coordinate.

In a further example, the anomaly may relate to anomalous hole event, ball location, player location, ball identification, player identification, or other anomaly.

In any combination of the above examples or in a another example, scoring data is received from automated analysis of sensor data identifying hole events, personnel interaction with electronic communication devices identifying hole events, or other sources, and wherein, as scoring data is being collected, the scoring module may be configured to make modifications and add missing data.

In any combination of the above examples or in a another example, the scoring module may be configured to provide access to scoring data to allow users to verify all or a portion of the scoring data, make modifications to existing data, enter missing data based on the user's visual observations, or combination thereof.

In any combination of the above examples or in a another example, users may indicate ball location on a touch screen of the electronic communication device that displays a digital map of the course.

In a further example, users may enter ball coordinates into the electronic communication device determined by identifying the ball location on a grid or other coordinate map overlaying a map of the course.

In yet another aspect, a tracking system for tracking golf play includes a tracking module configured to automatically generate a hole score for holes for players competing in a golf event based on tracking data collected by a plurality of sensor devices positioned around holes of a golf course. The tracked data may include tracked golf balls and identification of players, wherein the tracking module is configured to matched golf balls with identified players playing the golf balls to automatically generate the hole scores for the players.

In one example, the plurality of sensors may be configured to collect ball and player position data.

In the above or another example, the plurality of sensors may be configured to detect movement of objects, wherein detection of movement of objects may include measuring trajectory and position.

In any combination of the above examples or in a further example, the tracking system may include fixed and mobile sensor devices set up on the golf course and that are calibrated and continuously recalibrated as needed throughout an event based on mapping data.

In any combination of the above examples or in a further example, the sensor devices may be programmed to distinguish between and detect movement from 3D objects such humans, animals, golf balls, and other environmental objects.

In any combination of the above examples or in a further example, the sensor devices may be configured to identify and track movement of a golf ball or player in an area of the hole and transmit trajectory and location of the golf ball or player to tracking system components for use in operations of the tracking system.

In any combination of the above examples or in a further example, the sensor device may include a camera device, laser LIDAR device, or both, and wherein the sensor device is configured to track golf balls in an area of the hole, when the sensor device determines that an object in the area of the hole has moved, the sensor device is configured to generates a hole event, and wherein the hole event is associated with a from location coordinate determined from a calibrated sensor view of the sensor device.

In any combination of the above examples or in a further example, the sensor devices comprise a camera device, laser LIDAR device, or both, wherein the tracking system is configured to apply computer vision to camera data collected by the camera device.

In any combination of the above examples or in a further example, when a player or golf ball is detected within a sensor view of the sensor devices, computer vision or LIDAR detects and analyzes data about the player or golf ball to create relative events that trigger updates, notifications, or actions to be taken by the tracking system.

In any combination of the above examples or in a further example, the sensor devices may be configured to record and analyze objects in a sensor view including one or more of player movement and recognition, object recognition with respect to a ball of a specific player based group hitting order or last known position of the ball, ball movement, or club movement.

In any combination of the above examples or in a further example, player movement may include gait and player recognition may include clothing color, clothing type, or both.

In any combination of the above examples or in a further example, the tracking module uses person detection to identify players in video captured by camera sensors or LIDAR images captured by LIDAR sensors.

In any combination of the above examples or in a further example, the tracking module uses object detection to identify balls in video captured by camera sensors or LIDAR images captured by LIDAR sensors.

In any combination of the above examples or in a further example, the tracking module identifies players as they play a hole and tracks a ball of the player via multiple sensor types.

In any combination of the above examples or in a further example, the tracking module may include a programmed system that may be automated to automatically track individuals and objects via the sensor data.

In any combination of the above examples or in a further example, the tracking module may be configured to analyze sensor data comprising a sensor view and a course map together following calibration. The sensor view and course map line up such that when the tracking module detects a golf ball in the sensor view via automated object detection or when a user interacts with the sensor view, an X-Y coordinate in the course map can be converted to a latitude-longitude location of the golf ball.

In any combination of the above examples or in a further example, the tracking module may be configured to analyze sensor data comprising a sensor view and a course map together following calibration, wherein the sensor view and course map line up such that when the tracking module detects a golf ball in the sensor view via automated object detection or when a user interacts with the sensor view, an coordinate in the course map can be converted to a coordinate in another coordinate system via coordinate translation.

In another aspect, a tracking system for tracking golf play includes a prediction generator, an obstruction shot unit, and a shot simulator. The prediction generator may be configured to use a 3D surface model of a golf course and trajectory data of a golf ball hit on the golf course to generate a predicted final resting position coordinate of a golf ball, the trajectory data collected by a radar device. The obstructed shot unit may be configured to determine before the golf ball reaches a final resting position if a subsequent shot from the predicted final resting position to a next target location is obstructed. The shot simulator may be configured to run a plurality of simulations of possible typical shots from the predicted final resting position to the next target location to generate a shot cone from the predicted final resting position to the next target location.

In one example, the obstructed shot unit may generate a shot cone defined by flight paths of the simulated shots.

In a further example, the obstructed shot unit may apply the shot cone to a course map comprising a 3D representation of the golf hole by positioning the shot cone between the starting coordinate and the other coordinate location.

In another example, the shot may be determined to be obstructed if an obstruction in the 3D representation is within an interior portion of the cone.

In any combination of the above examples or in a further example, the obstructed shot unit may be further configured to determine if a subsequent shot from the final resting position of the golf ball is obstructed after the golf ball reaches the final resting position.

In still another aspect, a method of determining if a shot is an obstructed shot may include obtaining a starting coordinate; simulating possible typical shots from the starting coordinate to green; applying a shot cone obtained from shot simulations to course map including a 3D representation of golf hole; and determining shot is obstructed if a course obstruction extends into the interior of the shot cone.

In yet another aspect, a tracking system for tracking golf play includes a coordinate translator configured to receive a first coordinate corresponding to a golf course in a first coordinate system as an input and output a second coordinate in a second coordinate system that corresponds to the first coordinate in the second coordinate system.

In one example, the coordinate translator may be configured to output map data associated with a presented coordinate, and wherein the map data may include zone details associated with the presented coordinate.

In the above or another example, the coordinate translator may be configured to output zone details associated with a presented coordinate or a translated output.

In on or both of the above examples or another example, the coordinate translator may be configured to received zone details as an input and output a coordinate associated with the input in a first coordinate system or a second coordinate system.

In any combination of the above examples or in a further example, the first coordinate is a location coordinate of a golf ball in play, and wherein the coordinate translator may be configured to output zone details associated with the location coordinate.

In any combination of the above examples or in a further example, the first coordinate system may include X-Y coordinate values and the second coordinate system may include latitude-longitude coordinate values.

In any combination of the above examples or in a further example, the first coordinate system may include latitude-longitude coordinate values and the second coordinate system may include X-Y coordinate values.

In still yet another aspect, a method of tracking golf play includes=utilizing computer vision with respect to camera data collected by a camera device positioned on a golf hole to automatically detect and identify players, shots hit, ball in motion in the air, ball in motion on the ground, and final resting.

### BRIEF DESCRIPTION OF THE DRAWINGS

The novel features of the described embodiments are set forth with particularity in the appended claims. The described embodiments, however, both as to organization and manner of operation, may be best understood by reference to the following description, taken in conjunction with the accompanying drawings in which:

FIG. 1 is a schematic overview of a tracking system and various components that may be included in various embodiments of a tracking system described herein;

FIG. 2 is a diagram of a sensor network of a tracking system positioned around a golf hole of a golf course according to various embodiments described herein;

FIG. 3 illustrates example zone designations of a golf hole of a golf course according to various embodiments described herein;

FIG. 4 schematically illustrates an operation of a coordinate translator according to various embodiments described herein;

FIG. 5 illustrates a coordinate association method according to various embodiments described herein;

FIG. 6 illustrates a tracking system including a shot obstruction unit for determining if a shot is obstructed according to various embodiments described herein;

FIGS. 7A-7D graphically illustrates shot simulation (FIG. 7A), shot cone placement (FIG. 7B), and analysis of obstruction with respect to the inside of the shot cone (FIGS. 7C & 7D) to determine if a shot is obstructed according to various embodiments described herein; and

FIG. 8 illustrates a method of determining if a shot is obstructed according to various embodiments described herein.

### DESCRIPTION

A golf event tracking system may utilize an array of sensors to collect various sensor data to track and manage aspects of golf tournament play. Tracking may include tracking play, which may include tracking players, balls, scoring, statistics, or other event or production related aspects. The tracking system may allow for the collection and management of sensor data and data derived therefrom to support statistical information for golf events. The tracking system may be configured for operation in an environment with minimal human interaction while accurately and efficiently tracking play.

The tracking system may include a sensor network comprising various sensor devices configured to collect sensor data with respect to an event or otherwise utilize the senor data in tracking and other operations. The sensor data may comprise various types of tracking data such as location data, ball flight tracking data such as ball flight parameters, among others. Location data may be collected from the sensors prior to play, during play, after play, or combination thereof for application to various operations of the tracking system. Sensor data may also include calibration data used to calibrate the sensor devices. Sensor data may include map data of the course, typically prior to play to map the course, e.g., generate coordinate maps, 3D course models, zone maps, or other maps.

Example sensor devices may include global positioning sensors, e.g., global positioning sensors (GPS), radar devices, laser devices such as laser range finders or light detection and ranging (LIDAR) device, camera devices, or combination thereof. Radar devices may employ various radar technologies such as ground-to-air Doppler radar. Cameras devices may include digital video cameras, infrared cameras, ultraviolet cameras, thermal cameras, high speed cameras, machine vision cameras, or other similar optical capture devices. Lasers devices may include those employing various laser technologies, such as LIDAR, for measuring geographic features, laser rangefinders for collecting location data, or combination thereof. In some embodiments, GPS-enabled laser rangefinders or LIDAR devices may be implemented to measure distance of an object and collect location for that object. Such laser technologies may utilize real time kinematic (RTK), which increases the accuracy of location measurements by using a small ground network, including a GPS base station, to correct location measurements in real time. The tracking system or sensor devices of the sensor network may be configured with computer vision, e.g., utilizing image data collected by camera devices, radar devices, laser devices, or the like. In some configurations, the tracking system is configured to apply photogrammetry using image data obtained by camera devices, laser devices, radar devices, or combination thereof. For example, the tracking system may be configured to apply photogrammetry techniques to analyze photographs, other image data in sensor data to extract positions, measurements, or other information for use by the tracking system. In various implementations, electronic communication devices may be used to collect, record, or manage location data. Electronic communication devices may include a handheld tablet, smart device/phone, personal data assistant, or a dedicated electronic communication device, as examples. Electronic communication devices may include interactive map displays configured to receive user interactions, e.g., with a pointer or by touch, to indicate location for objects such as balls and players. Electronic communication devices may also be configured for use in combination with laser devices, such as rangefinders or LIDAR, for object detection, tracking, mapping, or combination thereof.

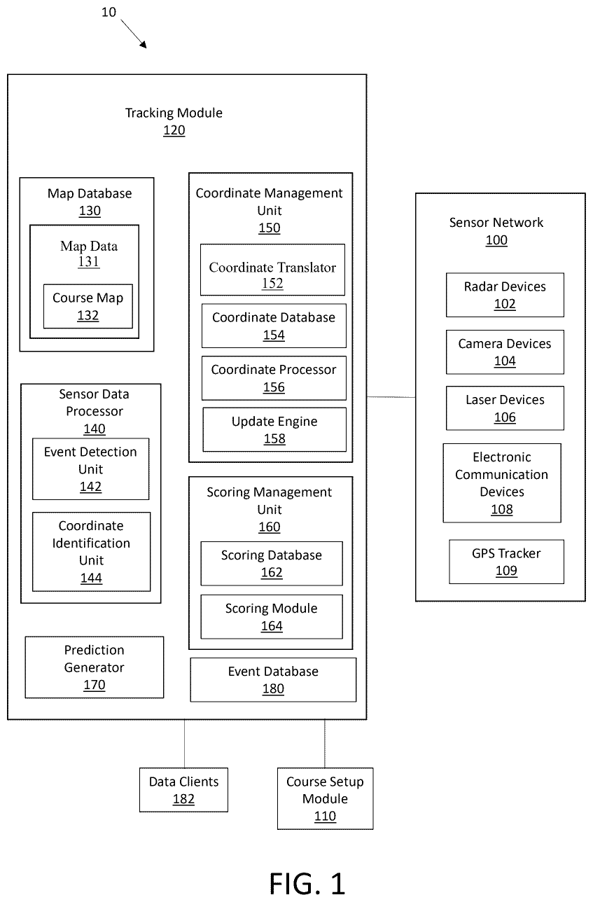

FIGS. 1-8 illustrate various embodiments of a golf event tracking system 10 and components and configurations thereof, wherein like numbers indicate like features. The tracking system 10 may include a processor and memory containing instructions that when executed by the processor perform the operations of the tracking system 10. The tracking system 10 may be implemented employing various computing hardware and sensor devices. Various components and operations of the tracking system 10 may be local or remote with respect to the golf event, other components and operations of the tracking system, or combination thereof. Components and operations may be distributed. Certain components and operations may operate in a cloud computing environment.

With particular reference to FIG. 1, the tracking system 10 may include a sensor network 100 or be configured to receive sensor data collected by a sensor network 100. The sensor network 100 includes various sensor devices configured to collected sensor data used to track play. In the illustrated example, the sensor devices include radar devices 102, camera devices 104, laser devices 106, electronic communication devices 108, and GPS trackers 109.

The tracking system 10 may include a tracking module 120 configured to identify events and coordinates with respect to objects on the course to track scoring and other data with respect to the event. The tracking system 10 or tracking module 120 thereof may be configured to perform the tracking operations with minimal human interaction. Indeed, events and coordinates may be identified, captured, and associated in an automated or autonomous environment. This may include automated or autonomous scoring of strokes, shot locations with respect to each stroke, player identification and tracking, ball tracking, statistics generation, among others. The tracking system 10 may also be configured with automated anomaly identification with respect to play, tracked data, or both that generates notifications directing for administrative review or targeted intervention as fail safes to ensure accuracy. The tracking module 120 may be configured to analyze the sensor data to track play. The tracking module 120 may include a map database 130 storing map data 131. The map data 131 may include one or more course maps 132 for one or more tournaments or rounds thereof. The tracking module 120 may include a sensor data processor 140 configured to process sensor data for detection of events and identification of coordinates related to score tracking operations. The sensor data processor 140 may include an event detection unit 142 configured to automatically create events, such as shot hit, by leveraging sensor data collected by various sensor devices, which may further include application of artificial intelligence. The events may be stored in an event database 180 for subsequent processing or association by a coordinate processor 156. The sensor data processor 140 may further include a coordinate identification unit 144 configured to ingest coordinates related to scoring and other tracking operations identified from sensor data.

In various embodiments, the tracking module 120 further includes a coordinate management unit 150 configured to manage aspects of coordinate processing, organization, and storage. The coordinate management unit 150 may include one or more of a coordinate translator 152 configured to translate coordinates between coordinate systems; a coordinate database 154 configured to store coordinates ingested coordinates; a coordinate processor 156 configured to associate coordinates with detected events to identify and record hole event coordinates for automated or autonomous scoring; or an update engine 158 configured to run an update function that compares coordinates for hole events stored in a scoring database 162 to coordinates associated with hole events via operation of the coordinate processor 156 and to update the coordinates if the previously recorded coordinates are different.

In some embodiments, the tracking module 120 includes a score management unit 160 configured to manage aspects of scoring and scoring related processes. The score management unit 160 may include a scoring database 162 configured to store scoring data, which may include various hole event data and in some embodiments non-scoring event data, statistics generated from scoring data, or both. The scoring data or other data generated by the tracking system 10 may be distributed to various clients 181. In the above or another embodiment, the score management unit 160 may include a scoring module 164 configured to monitor scoring data, event data, or both in the scoring database 162 or event database 180 and identify anomalies. The scoring module 164 may generate or act on notifications with respect to player, ball, or object anomalies. The scoring module 164 may provide notifications of anomalies or other events so users may take action to address the anomalies, e.g., obtain coordinates, in an otherwise automated tracking environment. The anomalies may relate to anomalous hole events, ball locations, player locations, ball identification, player identification, or other anomalies.

In one configuration, the tracking module 120 includes a prediction generator 170 configured to generate predicted final resting position coordinates for shots using ball trajectory and a 3D model of the course. In one example, the predicted coordinates are utilized by the coordinate processor 156 when determining accurate or “true” ball location coordinates for hole events.

In one embodiment, the tracking system 10 includes a course setup module 110 configured to collect tournament or round specific mapping data, e.g., setup position maps, for integration into or use with course maps 132 or other map data 131 used by the tracking system 10.

In various embodiments, sensor devices may be employed within the tracking system 10 to track players and events. The tracking system 10 may leverage sensor data collected by a sensor network 100 comprising an array of sensor devices positioned around a golf course during a golf tournament to identify players, detect events, or both. For example, the tracking system 10 may include a tracking module 120 in direct or indirect data communication with the sensors to receive and analyze the sensor data. The tracking module 120 may be centralized, local to sensor devices, distributed among sensor devices as part of a tracking module 120 network to receive and analyze sensor data collected by the various sensor devices, located in one or more physical locations around the course, located off-site in direct or indirect data communication with sensors to receive and analyze sensor data, cloud-based, or combination thereof. The tracking module 120 may comprise a programmed system that may be automated to automatically track individuals and objects via the sensor data.

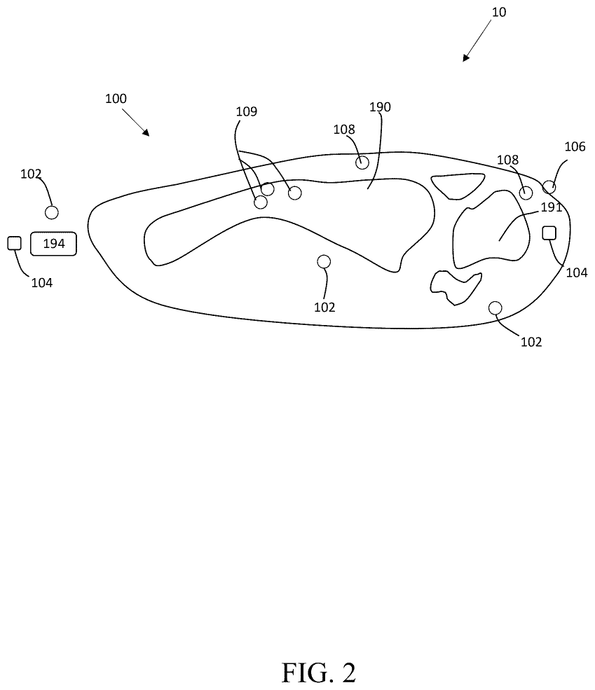

With further reference to FIG. 2, an example sensor network 100 including various sensor devices positioned around a hole of a golf course is illustrated. The hole includes a tee box 194, fairway 190, green 191, and bunkers 198. Various types of sensor devices may be used as introduced above. In the illustrated example, the sensor devices include radar devices 102, camera devices 104, laser devices 106, electronic communication devices 108, and GPS trackers 109. However, as noted above and elsewhere herein, various combinations of sensor devices may be used depending on the desired configuration. Thus, additional or fewer sensor devices or types of sensor devices may be used.

Radar devices 102 may be used to collect and record location data with respect to a golf ball, e.g., location data at any point in flight. In some embodiments, radar devices 102 may be used to collect data indicating location and trajectory of the ball flight of the golf ball. Tracking data collected by radar devices 102 may be used to identify location of a golf ball at impact with a golf club and impact with ground, e.g., ball strike location and impact location with respect to a shot. Radar may be used to determine ball flight and related location when the golf ball is at a location where the golf ball is no longer visible by camera devices 104 or laser devices 106, such as when the golf ball is behind obstacles, such as trees, stones, etc. In some embodiments, a radar device 102 may be used track golf balls up to 400 yards or more away from the radar source of the radar device 102 under various weather conditions, such as rain, fog, sunrise and sunset. In one implementation, the tracking system 10 utilizes radar devices 102 employing ground-to-air Doppler. Radar devices 102 may be located a one or more locations along a golf course or hole. In the illustrated example radar devices 102 are placed behind each tee and green of a course, and may be angled towards the center of the fairway. In some embodiments, the radar devices 102 may be operated by a human, robot, or be fully autonomous. In other embodiments, as described in more detail herein, some radar devices 102 may be mobile.

Camera devices 104 may be employed for various tracking tasks, such as tracking players, golf balls, or other objects. In one example, machine learning for optical recognition, computer vision, object detection, or combination thereof may be employed. For instance, the tracking system 10 may employ facial recognition, body recognition, gait recognition, clothing recognition, ball/shape recognition, or the like with respect to camera data to identify participants and/or balls, pair location with player or player ball, or both. In one embodiment, players may carry or wear an optical, electromagnetic, or reflective maker identifiable by a camera device 104 or an associated receiver that uniquely identifies the player. In another embodiment, camera devices 104 may utilize optical recognition/augmented reality (AR) to locate players and/or balls. Camera devices 12 may typically be located at known locations, but in some instances one or more camera devices 12 may be utilized in a mobile environment, e.g., utilizing RTK. In some embodiments, camera devices 12 may be used to identify motion and objects in captured video or image frames thereof and a laser device 106 comprising a GPS-enabled laser or laser rangefinder associated with a camera device 104 may target such objects to determine distance of the object from the camera device 104. Combining camera view angle with distance, the location of the object may be determined. In some embodiments, topology of the region may be mapped or determined by LIDAR, photogrammetry, or combination thereof and added to the distance calculations. In some embodiments, such camera devices 104 are operated by a human, robot, or fully autonomous. Camera devices 104 may operate in the visual spectrum and/or an optical spectrum to include one or more of the visual spectrum, ultraviolet spectrum, or infrared spectrum. As described in more detail below, in some embodiments, the sensor data processor 140 may comprise the camera device logic with respect to one or more of recognition, detection, computer vision, or other image analysis operations. In one example, the sensor data is transmitted to the sensor data processor 140 for analysis, which may be local or remote with respect to the camera device 104.

Laser devices 106, e.g., laser rangefinders, may be employed to measure and record the distances of objects, such as players or golf balls, from devices. In some embodiments, laser rangefinders may be GPS-enabled to enable the laser rangefinder to record location data for objects targeted by the laser rangefinder in addition to distance measurements. Laser rangefinders may utilize RTK to determine the location of an object with high accuracy, e.g., within centimeter. Laser rangefinders may be associated with other sensor devices in the tracking system 10 such that the laser rangefinder measures and records the distance of objects detected by other sensor devices in the t tracking system 10. In some embodiments, laser rangefinders may be operated by a human, robot, or fully autonomous. In one example, targeting of laser rangefinders may be remotely controllable by the tracking system 10. For instance, targeting of a laser rangefinder may be calibrated with a camera feed view and be mounted with positioning hardware that is remotely controllable by the tracking system 10 such that the tracking system 10 may, automatically or at the direction of a user, manipulate the laser rangefinder to target a particular location or object. In some embodiments, the tracking system 10 includes laser devices employing LIDAR to identify players and balls, track players and balls, or both. The tracking system 10 may utilize laser devices employing LIDAR and photogrammetry to collect point cloud data of the course or objects such as players or golf balls. The LIDAR and photogrammetry may be carried by a remotely piloted or autonomously piloted drone or aircraft. A flight path may be charted around the course in order to capture point cloud data, typically prior to play for generating a 3D model of the course. Ground control points may be determined by placing markers at known locations on the course. The ground control points may then be used by the tracking system 10 as reference points for generating the point cloud data of the course associated with a coordinate map.

In some embodiments, the tracking system 10 may implement electronic communication devices 108 that personnel interface with to interact with the tracking system 10. The electronic communication devices 108 may be handheld or portable for use by personnel to follow or position around play to target balls with associated rangefinders, interact with map displays, input coordinates from maps, utilize GPS location of the device to indicate location of balls, sensor devices, tees, holes, or other objects or locations. In one embodiment, an electronic communication device 108 includes an interactive display that displays digital maps of the course. Users may interact with the map to mark locations of golf balls, players, or both. In one example, one or more users carrying electronic communication devices 108 may be located at each hole to collect location data. In some embodiments, the electronic communication device 108 may be used to record the location of objects on the course and a laser device 108, e.g., a laser rangefinder, is integrated with or coupled with the electronic communication device 108 to measure the distance of the object. In this embodiment, users may use the electronic communication device to record the location of the object by either tapping the location on the digital map, using the associated laser rangefinder to record the distance and location of the object, or a combination thereof. In some embodiments, the electronic communication device may utilize RTK to determine and record the location of objects.

The sensor network 100 may include GPS trackers 109 worn or carried by players, caddies, or course personnel in order to obtain location data for use by the tracking module 120. For example, as players walk the course from hole-to-hole, a GPS tracker 109 may collect and record location data. The GPS tracker 109 may be individualized to uniquely identify the player wearing the device. The GPS tracker 109 output a location signal that includes identifying data elements associated with a specific player. The location data recorded from the device associated with a specific player may also contain additional information to uniquely identify that player. The location data recorded from the GPS tracker 109 may also be cross-referenced with location data recorded from other GPS-enabled sensor devices of the sensor network 100 used in the tracking system 10. The location data may be transmitted to tracking module 120 for processing, distribution, storage in the coordinate database 154 for use in tracking operations such as coordinate association. In one example, GPS coordinates with respect to players are utilized by the sensor data processor to train or confirm player identification with respect to the event detection unit 142 or camera devices 104. In some embodiments, the GPS coordinates may be translated to another coordinate system by the coordinate processor for use by the tracking system 10. In one example, the location data captured by the GPS trackers 109 are used to determine events such as player approaching own ball, player approaching another player's ball, player standing over ball, player entering tee box, baller entering green, or other event. While the present description generally refers to GPS, those having skill in the art will appreciate that such references apply equally to other Global Navigation Satellite Systems (GNSS), such as GLONASS, BeiDou, Galileo, or other current or future GNSS. GPS location may be augmented with WAAS (Wide Area Augmentation System), Differential GPS (DGPS), e.g., Global Differential GPS (GDGPS), real time kinematic (RTK), Continuously Operating Reference Stations (CORS), Signals of Opportunity (SOP)-based or augmented navigation, UWB, LTE, cellular, radio, television, Wi-Fi, other satellite signals, or the like.

As introduced above, the tracking system 10 may utilize map data 131 to generate a course map 132 comprising a 3D course model of the course. The course map 132 may be defined within a coordinate system such that locations or points in the course map 132 are associated with coordinates, which may be referred as a coordinate map. In one configuration, map data 131 may include cloud point data. Cloud point data may be collected using one or more of LIDAR, photogrammetry, or other suitable mapping technologies. In some embodiments, map data 131 may also include tournament round data. Tournament round data may include location data for various zones, e.g., zone outlines, or other boundaries on the course that map be separately mapped before a tournament. In some embodiments including a course setup module 110, one or more aspects of the tournament round data comprise or are obtained from a setup position map generated by the course setup module 110.

To generate the course map 132, ground control markers may be placed on the course at known locations and recorded. The tracking system 10 may then use the location data for the ground control markers as reference points for generating the course map 132 from the point cloud data. Coordinates of the ground control markers may be used to key the point cloud data to a coordinate system. The tracking system 10 may include point cloud processing hardware and software, which receives map data 131 for the course, extracts the point cloud data and the ground control marker location data, and processes the point cloud data and the ground control marker location data to generate a 3D course model in the course map 132.

In one embodiment, the course map 132 includes 3D course model comprising a measured surface model including surface features modeled in various levels of detail in the course map 132. For example, the course map 132 may include surface identification and properties such as surface contours, angles, relative heights of surfaces, or both. In a further example, detailed surface properties such as material, firmness, or the like may be incorporated into the course map 132 or provided separately. In one embodiment, surface features may be specified down to an inch or less in the course map 132. Increased level of surface detail included in the course map 132 may be used to enhance accuracy of predictions with respect to a prediction generator 170. The course map 132 may include manmade objects in addition to natural terrain and vegetation of the course property. For example, surfaces of objects on the property, such as camera towers or grandstands, may be modeled to include detailed 3D structures. In one example, trees may be mapped in detail beyond canopy dimensions, e.g., to include limbs and leaf locations, or a bridge may be mapped to include railings and posts.

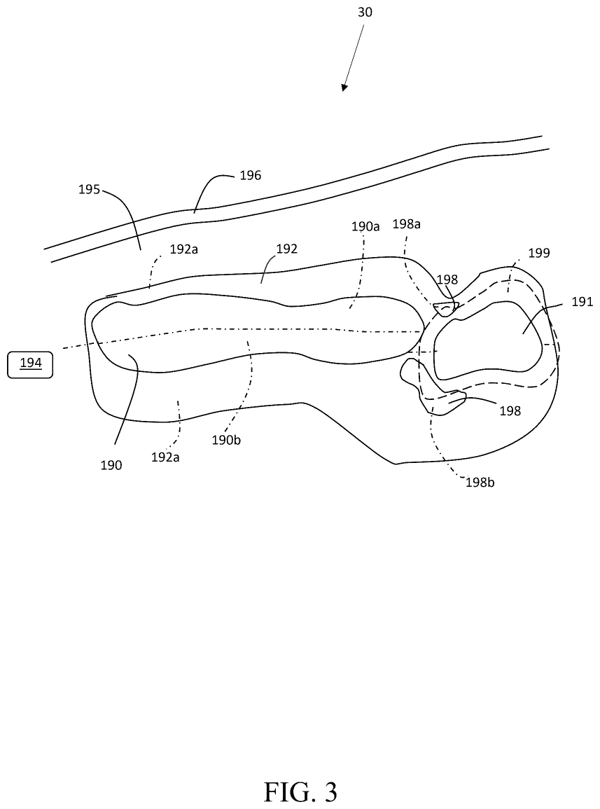

In some embodiments, map data 131 includes a zone map comprising detailed identification of zones of the golf course. Location data for various zones and boundaries on the course may be used to generate the zone map. Zones may correspond to parts of a golf course, such as tee box, fairway, green, hazard (bunker or water), rough, drop zone, or the like. FIG. 3 illustrates example zone designations of a zone map 30 of a portion of a hole and surrounding areas. Each zone may be associated with corresponding coordinates contained within the zone, which may be defined by a zone outline. The example zone map 30 includes fairway 190, green 191, rough 192, tee box 194, native area 195, cart path 196, and greenside bunker 198 zones. Zone maps 30 may include various levels of detail. For instance, zones may further include detailed zones comprising portions of a zone, such as left fairway 190a, right fairway 190b, left rough 192a, right rough 192b, left front greenside bunker 198a, right front greenside bunker 198b, and around the green 199. In further embodiments, zone maps 30 or other map data 131 may include feature mapping such as base ground material, grass, trees, shrubs and other vegetation. In some embodiments, the features also include manmade elements such as hospitality areas (e.g., grandstands, tents, etc.), camera towers, or other obstructions. In some embodiments, the feature mapping may include specifications such as type of material of the features (concrete, pavement, concrete block, oak, aluminum, pine, etc.).

In embodiments including a zone map 30, the course map 132 may include the zone map 30 or the zone map 30 may be configured to correspond with the course map 132 such that coordinates defined within the course map 132 correspond to or are translatable to the zone map 30. For example, a coordinate in the course map 132 may correspond, directly or via translation, to a coordinate in the zone map 30 such that cross-referencing the course map 132 coordinates with the zone map 30 identifies the zone that encompasses the coordinates. In one example, the course map 132 includes the zone map 30 and is generated by overlaying or associating the zone specifications from the zone map 30 with the surface identification from the course map 132 to identify zones within the course map 132.

As introduced above, in various embodiments, the tracking system 10 includes a course setup module 110 configured to capture location data for sensor device placement on the course. The course setup module 110 may utilize the location data to calibrate sensor devices, e.g., calibrate the sensor view/field of view of the sensor device to the course map 132 for use in object tracking relative to the course map 132. The sensor view may be calibrated to the coordinate map.

The course setup module 110 may include location tools and administrative functionalities to capture sensor device locations and reference point locations. This data may be imported into the tracking system 10 in real-time for use in sensor calibration.

The course setup module 110 may be executed on or utilize a handheld electronic device, which may include an electronic communication device 108, with an interface for users to capture location data on the golf course. In one example, the electronic communication device 109 includes an interactive display that displays digital maps of the course that the user may interact with to capture tournament round data. Tournament round data may include round-specific location data that identifies specific locations on the course relevant to the location tracking operations of the tracking system 10. The location tools may include GPS or augmented GPS. For example, the electronic communication device 108 and course may be equipped with RTK based GPS for location determination within a centimeter accuracy.

One or more users carrying a GPS-enabled or location enabled electronic communication device 108 may walk the course and interact with the electronic communication device 108 at specific course locations to collect specific tournament or round data. Example course locations that may be captured by the course setup module 110 include tee locations, hole locations, turn points, center of the fairway, broadcast TV camera locations, sensor locations for each sensor device, sensor calibration reference points, or combination thereof. This tournament or round data may then be incorporated into the map data 131 for use by the tracking system 10. For example, a course map 132 may include one or more setup location maps. A setup location map may be specific to a round of a tournament. For instance, setup locations with respect to tee and hole locations typically change between rounds of a tournament. One or more of broadcast TV cameras, sensor device locations, or combination thereof may similarly change between rounds. Thus, a course map 132 with respect to a tournament may include or incorporate different setup position maps for different rounds of the tournament. Setup position maps or the map data 131 thereof may be incorporated into zone maps 30, 3D course models, or coordinate maps. Indeed, course maps 132 may include one or more such maps integrated into a map data structure, which may include such maps or map data 131 thereof overlaid in an alignment. A course map 132 may include map data 131 keyed to coordinates of a coordinate map such that the various course map 132 features correspond to coordinates either directly or via translation.

The tournament round data captured at the sensor device locations and sensor reference points may comprise calibration data that the course setup module 110 utilizes to calibrate the sensor devices. In one example, the calibration data may be imported in real-time into the tracking system 10 as the user walks the course and interacts with the electronic communication device 108 at each sensor device location and sensor reference point on the course to capture the respective locations. The calibration data may then be used by the tracking system 10 or course setup module 108 thereof to calibrate each sensor device. Calibration may be periodic, intermittent, continuous, or when determined to be needed.

In some embodiments, the course setup module 110 may be used to capture location data comprising sensor location data used to determine the field of view for each sensor device. For example, a user may interact with the electronic communication device 108 at the sensor location to collect azimuth, angle/tilt, and height measurements for each sensor device. The sensor location data may be imported into the tracking system 10, which may then be used to determine the field of view for each of the sensors device at each of the corresponding sensor locations. In one example, the tracking system 10 may utilize the sensor location data to generate virtual or augmented reality representations of the field of view for each sensor.

Once the tracking system 10 has calibrated and determined the field of view for each sensor device, the tracking system 10 may then collect location data, e.g., coordinate data, for any object within the field of view of the sensor device. The tracking system 10 may send notifications or alerts based on movement detected by a specific sensor device or from the sensor data or changes in the field view. As described in more detail below, the notifications or alerts may, for example, inform users of events, prompt user action to review, modify, or update data derived from collected sensor data, adjust field of view of one or more sensor devices, notify users of predicted ball locations outside sensor device views, or trigger automated actions.

In one example, sensor data feed from a sensor device may be layered over the course map 132, e.g., a LIDAR point cloud, 3D course model, coordinate map, or combination thereof, to calibrate the collected sensor data to the course map 132 in order to collect location data for objects within the field of view. For instance, anchor points in the course map 132 may be aligned with the corresponding anchor points present in the sensor data feed. In some embodiments, this data may used by the sensor processing unit 140 in analysis of sensor data for operations such as computer vision, e.g., object detection, object recognition, or both, tracking, coordinate identification, as examples.

In various embodiments, the tracking system 10 includes or utilizes a coordinate translator 152 configured to execute coordinate translation related operations, translate coordinates between coordinate systems, provide information regarding coordinates corresponding to a golf course during a golf tournament, or other operations described herein.

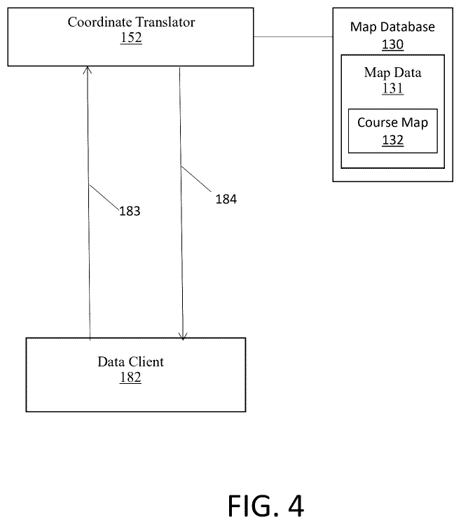

FIG. 4 illustrates an example operation of a coordinate translator 152 according to various embodiments described herein. The coordinate translator 152 may be configured to receive requests 183 from clients 182 for execution of coordinate translation related operations and output responses 184. The coordinate translator 152 may include a processor and memory containing instructions that when executed by the processor perform the operations of the coordinate translator 152. The coordinate translator 152 may comprise a server including or configured to access the map database 130 to provide a response 184 to requests 183 for coordinate translations. The coordinate translator 152 may employ various architectures, such as centralized, decentralized, distributed, or cloud-based. Clients 182 transmitting requests 183 may include tracking system 10 components, which may be referred to as modules, units, processors, processes, engines, or the like. In some embodiments, clients 182 may include external or third party systems, programs, applications, or the like. In one configuration, the coordinate translator 152 comprises an application program interface (API), e.g., internal, external, or partner API. For instance, the coordinate translator 152 may comprise an API configured to interface with clients 182, which may include client systems, programs, applications, or the like. Clients 182 may call the coordinate translator 152, e.g., send a request 183, for coordinate translation, detailed information regarding coordinates, or both and output responses 184 to the request 183. In one example, the coordinate translator 152 provides a rest API endpoint to which clients 182 call the coordinate translator 152 to request an appropriate operation.

The coordinate translator 152 may include or access the map database 130 to obtain coordinate data for use in the coordinate translation related operations. The map database 130 may include map data 131 with respect to one or more courses. In one embodiment, the coordinate translator 152 may be configured to read in map data 131, e.g., survey CAD models, of the golf courses to systematically provide information about the course. The map data 131 may include one or more course maps 132, which may be in image format, text format, or both. Course maps 132 for a course may be in a combined or separate format. The map data 131 may include course maps 132 or map data 131 for multiple golf course wherein the course maps 132 or map data 131 are defined in multiple coordinate systems. For example, course maps 132 may include one or more world plane coordinate systems and one or more universal coordinate systems wherein locations are mapped with respect to the multiple coordinate systems. Coordinate maps may include or be keyed to coordinates of a coordinate system, which may include a cartesian, geodetic, geocentric, latitude-longitude, such as GPS, or proprietary system. Coordinate maps may be keyed by overlaying or otherwise calibrating the course map 132 to coordinates such that locations on the map align with corresponding coordinates in one or more coordinate systems. In one example, a coordinate map comprises a 3D point cloud wherein the points are defined within a cartesian space, keyed to another coordinate system, or both. The point cloud may be prepared utilizing LIDAR or LIDAR together with photometry as described in more detail elsewhere herein. According to one methodology, coordinates may be translated between coordinate systems utilizing a projection file. In one embodiment, maps may be overlaid such that one to many zones that are overlayed define zones such as fairway, rough, green, tee box, and the like, and corresponding coordinates. A location defined by X-Y coordinates may also be defined by latitude-longitude coordinates. Accordingly, a request specifying X-Y coordinates and identifying the course that the coordinates are found may cause the coordinate translator 152 to look-up the specified coordinates for the identified course and respond with the latitude-longitude coordinates corresponding to the X-Y coordinates for the course. In various embodiments, map data 131 comprises course maps 132 that include coordinate maps.

In some embodiments, the course maps 132 are tournament specific. For instance, one or more aspects of map data 131 related to a course may correspond to the course during a specific tournament. Thus, a golf course wherein multiple tournaments have been or are scheduled to be played may have multiple associated course maps 132, which may include multiple course map 132 versions. For example, a course may have a first course map 132 including a coordinate map and zone map 30, e.g., course map 132 with different defined zones. As introduced above, course maps 132 or versions thereof may also be specific to a round of a tournament. Therefore, a request may specify a tournament number, round number, or both and coordinates of the course and the coordinate translator 152 may look up the specified coordinates for the identified course and return the coordinates translated into another coordinate system, details about the coordinate location during the tournament, or both.

In various embodiments, the coordinate translator 152 may read in the map data 131. Depending on the configuration, the map data 131 may include features of the course, hole numbers, course zones, or combination thereof associated with the coordinates. For example, the map data 131 may include a measured surface model specifying ground topography, object topography, or both of coordinates of a golf course. Coordinates may correspond to world plane coordinates together or separate from a universal coordinate system, such as GPS coordinates. In various embodiments, the map data 131 includes coordinate elevations. The map data 131 may be collected using suitable technology, such as those described herein, e.g., LIDAR, laser, photogrammetry, GPS, or the like. In some embodiments, individuals on foot, aircraft, drones, or robots may survey the property utilizing such technology. In one example, LIDAR, laser, and photogrammetry carried by remotely piloted or other aircraft as well as by walking or robotic ground-based devices are used to collect map data 131. Surface models may include three-dimensional coordinate models, which may comprise a digital surface model measured by LIDAR, photogrammetry, radar, or combination thereof. In one embodiment, the map data 131 may include computer generated versions of a course, such as a survey CAD model. Request 183 may request map data associated with coordinates, such as zone, topography, elevation, or the like.

In various embodiments, the coordinate translator 152 may be configured to respond to requests 183 for one or more coordinate translation associated operations related coordinate translation (e.g., X-Y coordinate translation, or latitude-longitude coordinate translation), zone related coordinate information (e.g., map zone, detailed zone, TV zone, map data 131, around the green, zone crossing, fairway center side, fairway distance, distance to green edge, green geometry, ball move, impact point, or Z-value).

In various embodiments, the coordinate translator 152 is configured to translate a first coordinate of a first coordinate system into a second coordinate of a second coordinate system. In one example, the first coordinate system is a world plane coordinate system and the first coordinates includes X-Y coordinate values. The second coordinate system may include a universal coordinate system and the second coordinates may include latitude-longitude coordinate values within the universal coordinate system. In one example, the coordinate translator 152 may be configured to respond to requests 183 for world plane coordinate system coordinates when the request includes universal coordinate system coordinates. For instance when provided with X-Y coordinates, the coordinate translator 152 may look-up and return latitude-longitude coordinates in decimal form via the API utilizing the map data 131 accessed from the coordinate database 154. Additionally or alternatively, when provided latitude-longitude coordinates, the coordinate translator 152 may look-up the coordinates and determine which course the coordinates belong and return X-Y coordinates corresponding to the provided latitude-longitude coordinates. In a further example, the response 184 may also return a course corresponding to the coordinate, tournament corresponding to the coordinates, other detailed information regarding the coordinate, or combination thereof. In one embodiment, the coordinate translator 152 is configured to return which course and hole number the coordinates are located. In a further embodiment, the coordinate translator 152 is configured to return where on a hole the coordinates correspond, e.g., a zone or designated portion of the hole such as tee, fairway, or green. Additionally or alternatively, the coordinate translator 152 may return a distance the coordinates are from a location, such as the hole. In one configuration, the client 182 may specify the location in the request 183. Requests 183 will typically include a course identification, e.g., tournament, round, or both, when the coordinate translator 152 is configured to handle requests 183 from multiple tournaments.

As introduced above, the map data 131 may include a zone map 30 comprising detailed identification of course zones. Zone maps 30 may identify zones that may be as specific or as general as needed. Zones may include various grounds designations, physical features, or both within the course of play and, in some embodiments, outside the course of play, such as out-of-bounds areas within the vicinity of the course where a player may potentially hit a ball. Thus, in some configurations, zones may correspond to areas one or both of within or around the course of play, such as physical structures (e.g., natural and/or manmade objects, structures, and features). For example, zones may correspond to parts of a golf course, such as tee box 194, fairway 190, green 191, hazard (bunker 198 or water), rough 192, drop zone, and the like. Zones may be provided in levels of specificity, e.g., detail. For instance, a tee box 194 zone may include one or more detailed tee box 194 zones such as a tee left, tee right, or tee center detailed zone. Zones may include one or more zones corresponding to a fairway, such as fairway bunker, or the like. In a further configuration, zones corresponding to a fairway may include detailed zones such as one or more of left fairway 190a, right fairway 190b, left fairway bunker, right fairway bunker, or the like. Zones may include one or more zones corresponding to a hazard, such as hazard, grass bunker, fairway bunker, waste bunker, water, or the like. In a further configuration, zones corresponding to a hazard may include detailed zones such as one or more of front center greenside bunker, front left greenside bunker 198a, left greenside bunker, left rear greenside bunker, rear greenside bunker, right greenside bunker, right rear greenside bunker, right front greenside bunker 198b, or the like. Zones may include one or more zones corresponding to a rough, such as primary rough, intermediate rough, greenside rough, or the like. In a further configuration, zones corresponding to a rough may include detailed zones such as one or more of left rough 192a, right rough 192b, left intermediate, right intermediate, or the like. Zones may include one or more zones corresponding to or related to a green, such as around the green 199, fringe, or the like. Zones may include one or more zones corresponding to landscape and/or nature features, such as bush, tree, step, landscaping, path, rock outline, tree outline, dirt outline, native area 195, water, or the like. Zones may include physical features such as manmade structures positioned around the course such as one or more of grandstands/seating, camera tower, hospitality tent, building, cart path 196, pedestrian path, walk strip, wall, bridge, or the like. In some embodiments, one or more zones may be identified as other or unmapped.

As introduced above, the coordinate translator 152 may include or access detail course maps 132 from the map database 130 that include coordinates and zone designations corresponding to the coordinates. The coordinate translator 152 may utilize the zone designations to provide zone details related to coordinates. For example, the coordinate translator 152 may be configured to provide zone details about location of coordinates in a response 184, given coordinates. The coordinates may be X-Y coordinates corresponding to a world plane coordinate system or latitude-longitude coordinates of a universal coordinate system.

Map data 131 may include and the coordinate translator 152 may be configured to return a zone detail response 184 with respect to a request 183 for a map zone corresponding to the coordinates. A map zone corresponds to a main zone that describes the location of the coordinates, such as tee box 194, green 191, fairway 190, primary rough, cart path 195, hazard, or the like. Thus, the coordinate translator 152 may respond to map zone requests 183 with identification of a map zone corresponding to provided coordinates.

Additionally or alternatively to map zones, map data 131 may include and the coordinate translator 152 may be configured to return a zone detail response 184 with respect to a request 183 for detailed zone corresponding to the coordinates. A detailed zone corresponds to a more detailed description of the location of the coordinates, usually indicating whether a coordinate is left or right of the centerline of the golf hole. Examples of detailed zones include left fairway 190a, right fairway 190b, right rough, left rough, left bunker, right bunker, left front greenside bunker 198a, right front greenside bunker 198b, left rear greenside bunker, right rear greenside bunker, or the like. Thus, the coordinate translator 152 may respond to detailed zone requests with identification of a detailed zone corresponding to provided coordinates.

In one embodiment, map data 131 includes and the coordinate translator 152 is configured to return a zone detail response 184 with respect to a request 183 for TV zone requests corresponding to the coordinates. A TV zone requests may request which of any defined zones used by broadcasters do coordinates lay. Thus, the coordinate translator 152 may respond to TV zone requests with identification of a TV zone corresponding to provided coordinates.

In some embodiments, map data 131 includes or the coordinate translator 152 is otherwise configured to return a response 184 to a request 183 for around the green with respect to the coordinates. Around the green 199 is a predefined zone that extends outward 30 yards from the edge of a green, but which does not include the green itself, thereby creating a “donut” shaped area. Thus, the coordinate translator 152 may respond to around the green requests with an indication whether the coordinates location is around the green. For example, the response may include whether or not provided X-Y coordinates is within the around the green zone. In this or another configuration, the response may include whether or not a provided latitude-longitude coordinates are with the around the green zone.

Additionally or alternatively to any of the above responses 184, the coordinate translator 152 may be configured to return a response 184 to a request 183 for zone crossing with respect to the coordinates. For example, the coordinate translator 152 may be configured with a function that returns all the map zone boundaries that lie along a line between the coordinates (e.g., X-Y coordinates) and a pin location of the hole corresponding to the coordinates. For each boundary crossed, the coordinate translator 152 may provide the map zone being entered, the coordinates of the point where the line intersects the zone boundary, and the distance from the coordinates to that intersection point. In one configuration, zone crossing requests may be applied to latitude-longitude coordinates.

Additionally or alternatively to any of the above responses 184, the coordinate translator 152 may be configured to return a response 184 to a request 183 for fairway center side with respect to the coordinates. The coordinate translator 152 may include an indication, e.g., set a value, that indicates whether the coordinate lies on the left or right side of the fairway centerline. For example, a request including coordinates for a ball location following a stroke may include a fairway center side request. In various embodiments, fairway center side requests may be requested with respect to X-Y coordinates, latitude-longitude coordinate, or either.

In one embodiment, the coordinate translator 152 is configured to return a response 184 to a fairway distance request with respect to the coordinates. A request 183 for fairway distance may return a distance from a coordinate to the fairway centerline, the closest edge of the fairway, or both. For example, the coordinate translator 152 may provide the distance from an X-Y coordinate corresponding to ball location following a stroke to both the fairway centerline and to the closest edge of fairway.

Additionally or alternatively to any of the above responses 184, the coordinate translator 152 may be configured to return a response 184 to a request 183 for distance to green edge with respect to the coordinates. A distance to green edge request may return the distance from the coordinates to the nearest edge of the green. For example, coordinates on the green or for coordinates corresponding to ball locations following a stroke that stops on the green, the coordinate translator 152 may provide the distance from the shot's ending location to the nearest edge of the green.

In one embodiment, the coordinate translator 152 may be configured to return a response 184 to a request 183 for green geometry. For each round's pin location, and, in some embodiments, for future round pin locations, the coordinate translator 152 may be configured to calculate the coordinates representing the front of the green, and the coordinate of the closest edge to the green perpendicular to the line between the pin and the front of the green. Thus, in such embodiments, a client 182 may submit a green geometry request that identifies a tournament and round to cause the coordinate translator 152 to return the calculated coordinates.

Additionally or alternatively to any of the above responses 184, the coordinate translator 152 may be configured to return a response 184 to a request 183 for a ball move. Given, for example, course identification, coordinates, and map zone, the coordinate translator 152 may return the closest coordinates within the correct map zone. For instance, a request 183 for a ball move may return the closest coordinates in a specified zone to provided coordinates. In an example use case, if a sensor device returns a coordinate for a ball that corresponds to the rough 192 and personnel walking the course with an electronic communication device 108 to indicate ball location zones indicate the ball is located in the fairway 190, the tracking system 10 or scoring module 164 thereof may apply a hierarchical rule and accept the fairway indication entered by personnel and the ball move request will return coordinates in the fairway 190 closest to the original coordinates that was in the rough.

In one embodiment, the coordinate translator 152 is configured to return a response 184 to a request 183 for an impact point. For example, given a tournament identification, hole number, and a golf ball's trajectory, the coordinate translator 152 may calculate the point at which the ball's trajectory will intersect ground level and respond with the corresponding coordinates, which is the calculated impact point of the golf ball.

Additionally or alternatively to any of the above responses 184, the coordinate translator 152 may be configured to return a response 184 to s request 183 for a Z-value or elevation. For example, given coordinates (e.g., X-Y or latitude-longitude coordinate) the coordinate translator 152 may return an elevation of that coordinate.

Thus, the coordinate translator 152 may be configured to respond with detailed information regarding a coordinate location on a course that is tournament specific, which may also be round specific. However, as some requests 183 and responses 184 do not require tournament specific information, some requests 183 and responses 184 may be specific to a course without being tied to a particular tournament or round thereof. Requests 183 will typically include a course identification, e.g., tournament, round, or both, when the coordinate translator 152 is configured to handle requests 183 from multiple tournaments. In some embodiments, even when coordinates are provided in a universal coordinate system or coordinate system wherein the location may be identified without being provided course identification, requests 183 may include course identifications, particularly in instances wherein the request 183 is requesting output specific to a tournament or round wherein the output, such as zone, TV zone, around the green, fairway center side, fairway distance, distance to green edge, setup, ball move, impact point, Z-value, or the like may vary between tournaments or rounds of the tournament. It is to be appreciated that in some embodiments, requests 183 may not specifically include tournament identification, e.g., requests 183 are only being received by the coordinate translator 152 related to a known tournament or the coordinate translator 152 is configured for operation with respect to a particular tournament. Thus, the subject tournament may be implied by the configuration and operations of the tracking system 10. Similarly, as noted above, course identification may include round identification. In some embodiments, responses 184 may specify tournaments, rounds, or both the coordinates or other output that the coordinates or other output correspond. In some embodiments, clients 182 may subscribe to one or more coordinate translator 152 output operations such that the when the tracking module 120 provides coordinates to the client 182, the coordinates are automatically accompanied with the output response the client 182 corresponding to the subscription. Thus, requests 183 may include subscription requests 183 that result in automated responses 184 when the information is available.

In one example, requests 183 may be received for coordinates, zone, zone detail, TV zone coverage(s), sensor zone coverage(s), distance for an event, such as player location, location of ball, ball impact location, ball final resting position location, shot hit location, or the like, and the coordinate translator 152 is configured to output zones, coordinates of player or ball, distance to a pin, distance between impact and resting position, distance of shot, detailed zone information, zone crossing, around the green, or other requested information. The coordinate translator 152 may access one or more tracking system 10 components, such as the tracking module 120, sensor network 100, prediction generator 170, event database 180, coordinate processor 156, scoring database 162, or scoring module 164, to obtain the requested information to process the request 183.

Responses 184 that include measurements, such as distances and elevation, may utilize any desired measurement system and scale. For example, distances or elevation may be returned in yards, feet, inches, or to the inch. Metric system may similarly be used or available upon request. In some embodiments, distance from the coordinate to the intersection point with respect to zone crossing or distance to edge of green may be provided in inches. In this or another embodiment, elevation may be returned in feet.

The present disclosure describes various embodiments of a tracking system 10 and methods of tracking detailed scoring data including associating coordinates corresponding to ball locations with hole events. The tracking system 10 may operate in an environment wherein large amounts of tracking data are being transmitted from multiple sensors devices, multiple types of sensor devices, and personnel. Operations of the sensor devices and the tracking module 120 may take place in an automated environment with little to no human intervention. For example, the tracking data may include ball location coordinates and data logging with respect to the occurrence of hole events. Example hole events may include player strokes that correspond to the tracked ball location coordinates, drops, among others. However, as multiple sensors are collecting the ball location data, with varying levels of accuracy, multiple coordinates may correspond to a same hole event. Sensor devices collecting ball location coordinates may also be partially or fully autonomous or automated such that the ball location coordinates may not be transmitted with data identifying a corresponding hole event, e.g., player and stroke. Additionally or alternatively, every sensor device or type of sensor device, when multiple types are used, may not collect coordinates for every hole event. Accordingly, it can be difficult to determine which coordinates correspond to which hole events. This problem is magnified in a tournament environment wherein up to four players are playing each hole of an 18 hole course at the same time with each player tallying multiple hole events on each hole. However, the tracking system 10 disclosed herein may be configured to address the complexities related to automated hole event and coordinate tracking in the golf tournament environment utilizing multiple coordinate sources, such as sensor devices.

The tracking system 10 may be configured for tracking golf play on a golf course during a tournament. Collected tracking data may comprise detailed scoring data including one or more of hole event data, coordinate data associated with the hole event data, or both. The tracking system 10 may include a plurality of different coordinate sources configured to collect coordinate data and transmit the coordinate data to the coordinate database 154. The coordinate sources may include sensor devices configured to track balls such as radar devices 102, cameras devices 104, lasers devices 106, GPS trackers 109, or combination thereof. For example, the tracking system 10 may comprise a sensor network 100 or obtain tracking data comprising coordinates from the sensor network 100 including coordinate sources comprising sensor devices, such as those described above. The tracking system 10 may also include source of the hole events configured to collect tracking data comprising hole event data that identifies hole events. As described in more detail below, in some embodiments, source of the hole events may comprise or utilize tracking data collected by one or more of the sensor devices to assist in hole event identification or automated hole event tracking.

The sensor data processor 140 may be configured to process sensor data collected by sensor devices of the sensor network 100. The sensor data processor 140 may be configured to process the sensor data to perform object detection, object recognition, player identification, event detection, coordinate identification, among others. For example, the sensor data processor 140 may include an event detection unit 142 configured to analyze sensor data, e.g., sensor views, to detect events. The events may be hole events or other events described herein or otherwise. The sensor data processor 140 may include a coordinate identification unit 144. The coordinate identification unit 144 may be configured to analyze sensor data to identify coordinates corresponding to object locations, such as player locations, ball locations, object locations used for calibrating sensor views, among others. Thus, the sensor data processor 140 may be configured to calibrate sensor views such that sensor views align with coordinates of a coordinate map, as described in more detail herein. The sensor data may include raw sensor views, information about detected objects, coordinates with respect to location of detected objects, events, or combination thereof. In one embodiment, the sensor data processor 140 may comprise integrated logic with sensor devices to collect, process, and store data. Thus, one or more processing operations of the sensor data processor 140 may be integrated with the sensor devices of the sensor network 100. For example, the sensor data processor 140 may comprises a processor associated with a sensor device and including logic to perform one or more operations described herein with respect to the sensor data processor 140. For instance, sensor devices may be configured for radar, computer vision (e.g., object detection, object recognition, or both), LIDAR, or both computer vision and LIDAR with respect to players, balls, or other objects. Sensor devices may be configured to use the radar, computer vision (e.g., object detection, object recognition, or both), LIDAR, or both computer vision and LIDAR to track the objects and generate data with respect to the object. In some embodiments, operations of the sensor data processor 140 may be distributed among one or more of the sensor devices. One or more sensor devices may be controllable by the sensor data processor 140. In one embodiment, the sensor data processor 140 receives raw sensor data, which may include calibrated raw sensor data, from the sensor devices and processes the sensor data as described herein. In various embodiments, event data sources comprise sensor devices and the event detection unit 142, and coordinate data sources comprise sensor devices and the coordinate identification unit 144 comprise coordinate data sources. In one embodiment, coordinate data sources may further comprise the prediction generator 170. The event detection unit 142 may be configured to process hole events and transmit the hole events to the event database 180, and the coordinate identification unit 144 may be configured to process capture coordinates and transmit the coordinates to the coordinate database 154.

The coordinate processor 156 may be configured to access the event database 180 and coordinate database 154 and associate the coordinates with the hole events to provide coordinates corresponding to each hole event. The coordinates may correspond to hole events such as “shot to” location or “shot from” location. In one example, the “shot from” location coordinates are determined from the “shot to” coordinates associated with the previous “shot to” hole event for the player. This detailed scoring data including the associated coordinates and hole event may be transmitted to a scoring database 162 for use by various data clients 182, such as applications, websites, data platforms, television broadcasts, among others. In some embodiments, the coordinate processor 156 may analyze the detailed scoring data for automated scoring for player strokes that includes detailed shot locations, e.g., coordinates, zones, or other locations, distances, e.g., distance of shot, distance of shot from the pin, or distance of the shot from the hole, or other details with respect to every shot for the competing players.

In embodiments including an update engine 158, the update engine 158 may be configured to run an update function that compares coordinates for hole events stored in the scoring database 162 to coordinates associated with the hole events via operation of the coordinate processor 156 and update the coordinates if the previously recorded coordinates are different. Additionally or alternatively, the update engine 158 may mark differing coordinates for further review, generate a notification that coordinates have been updated, or both. In one example, an update, notification, or both is further transmitted to data consumers clients 182 that have accessed or otherwise been provided with the previously recorded coordinates with respect to the hole event.

The tracking system 10 and components thereof may be configured to communicate coordinates, hole events, and other data described herein over various communication networks, such as a mesh network, a local network, a cloud-computing network, an IMS network, a VoIP network, a security network, a VoLTE network, a wireless network, an Ethernet network, a satellite network, a broadband network, a cellular network, a private network, a cable network, the Internet, an intranet, an internet protocol network, MPLS network, a content distribution network, short range wireless communication network, or any combination thereof. One or more source of the hole events, coordinate sources, or combination thereof may be configured to communicate directly with location elements, such as location networks, global satellite constellation infrastructures via the various communication networks or indirectly via another tracking system 10 device or network device.

In some embodiments, hole events may be include personnel that enter stroke events into electronic communication devices 109 for transmission to the event detection unit 142 or event database 180. However, in some embodiments, hole events are primarily or exclusively detected via automated analysis of sensor data. For example, absent an anomaly, such as one detected by the tracking module 120, e.g., the scoring module 162 or sensor data processor 140, events are exclusively detected via autonomous analysis of sensor data. For example, radar devices 102 may be employed to detect swings, which may be further combined with detection of ball movement proximate to the location of the detected swing. In some embodiments, additional or different sensor devices that those illustrated in FIG. 1 may be employed to collect sensor data for autonomous event detection. For example, sensor data corresponding to player motion indicative of a swing, such those collected utilizing accelerometers, gyroscopes, or both worn by players that detect motion. Sensor devices that detect sound, such as sound of a ball strike, may additionally or alternatively be used, either worn by players, positioned around the course, or otherwise. For example, swing detection may be paired with ball strike sound detection. Sensor devices worn by players may transmit detected sensor data paired with identification of the player. In some embodiments, sensor devices may be partially or fully automated devices, for example, using optical recognition to hole events and identify players in which hole events correspond. In some embodiments, the tracking system 10 is configurable to enable administrative review or confirmation with respect to one or more events, event types, events from particular event sources, or event source types.

The hole events may include or be associated with data elements corresponding to the hole event, such as a timestamp for when the hole event occurred, e.g., ball strike, ball in air, ball impact, or player swinging. Data elements may also include a geographic identifier that associates the hole event to an area or hole of the course. In some embodiments, data elements included or associated with hole events include identification of the player the hole event corresponds. The hole event may be or be associated with a data element comprising a hole event type identifier. For example, the hole event type may include an indication of stroke number (1, 2, 3, 4, 5), type of stroke (tee shot, approach, putt, drop), or combination thereof. In one configuration, stroke numbers may be used to determine type of stroke for purposes of hole event type. The hole event type, type of stroke, or both may be used by the coordinate processor with respect to identification of candidate coordinates or filtering of the same. For instance, whether the hole event follows a hole event having a shot to location that corresponds to the shot from location of a current hole event to be associated with coordinates.

Various coordinate sources may be deployed. For instance, coordinate sources may be comprise sensor devices or sensor data collected by sensor devices such as radar devices 102, camera devices 104, laser devices 106, electronic communication devices 108, GPS trackers 109. In one embodiment, coordinate sources may also include the prediction generator 170.

Radar devices 102 may collect radar data implemented to track object movements. For instance, radar may be used to track ball flight, which may include location, velocity, trajectory, acceleration, or other parameters of ball flight. As noted above, the same or different radar devices 102 may employ radar to detect swings. Multiple radar devices 102 may be positioned around the course to collect coordinates from the radar data. Radar devices 102 may typically be located at known locations, but in some instances one or more radar devices 102 may be utilized in a mobile environment, e.g., utilizing RTK base stations or network, such as RTK based GPS, or other location methodologies. Coordinate sources utilizing radar data may provide coordinates with respect to a “shot from” location, i.e., where a ball flight initiated, and coordinates of an impact location. Radar data used for identifying coordinates may typically be captured by radar devices 102 that are automated or autonomous, e.g., operated by an autonomous robot. However, in some embodiments, radar devices 102 used to collect radar data for coordinate identification may be operated by a human, e.g., mobile.

Camera devices 104 may collect camera data for object identification, to track object movements, determine distance or location of objects, as examples. Coordinates collected from camera data may include a “shot from” coordinate, a final resting position coordinate, or both. Ball impact coordinates may also be collected. The camera devices 104 may operate in the optical spectrum or one or more of the visual spectrum, ultraviolet spectrum, or infrared spectrum. Cameras devices 104 used to capture camera data coordinate identification may typically be located at known locations, but in some instances one or more camera devices 104 may be utilized in a mobile environment, e.g., utilizing RTK base stations or network, such as RTK based GPS, or other location methodologies with respect to determining the location of the camera. One or more of the camera devices 104, coordinate identification unit 144, or both may be fully or partially automated or comprise an autonomous robot. In another or a further embodiment, mobile camera devices 104 carried by personnel may be used.

Camera devices 104 may include logic configured for optical recognition to identify balls, players, or other objects. In one embodiment, camera coordinate sources may utilize optical recognition/augmented reality (AR) to identify balls. In this or another embodiment, camera coordinate sources are configured with computer vision to one or more of identify objects, perform player recognition, detect motion, determine distance, or determine location.

In some instances, a ball may enter the field of view of a camera device while in flight and the starting point of tracking by the camera device is the first place the ball entered the field of view. The tracking system 10 may match this camera data with other sensor data collected by other sensor devices to having overlapping or adjacent fields of view to obtain track the event or otherwise obtain a complete tracking of the ball.

Camera coordinate sources may utilize camera data for location determination with respect to objects, such as balls, players, or other objects. Camera coordinate sources may be configured to employ computer vision, photogrammetry, or location determination technique applied to camera data alone or in combination with other sensor data collected by the sensor network 100. For example, location determination may include determining a distance of an object from the camera device, other objects in the field of view, or combination thereof. The distance may be used to determine locations of the objects, e.g., coordinates of the objects, in the camera data. In one example, camera coordinate sources are configured to calculate the distance a ball or other object of known size by comparing the optically captured size of the object to that of the known size of the object. In this or another example, camera coordinate sources may be coupled with a laser rangefinder to target objects in the field of view of the camera device. Distances may be with respect to a target object in which a coordinate is to be collected and transmitted to the coordinate database, such as a player or ball. Similarly, distances may be with respect to reference objects that the camera coordinate source may use to scale or otherwise calibrate camera data in order to determine distance, position, size, dimensions, orientation, or other aspect of an object, e.g., using photogrammetry, computer vision, or other technique.

In one embodiment, camera coordinate sources are configured to combine view angle with distance to determine location of an object in the camera data. For example, determination of the angle of the camera device may be used by a camera coordinate source to plot the location of an object at the distance and angle from the camera relative to a map of the region around the camera to thereby identify coordinates corresponding to the location. In some embodiments, topology of area within the field of view of a camera device is mapped or determined and added to the distance calculations. Location determination may be enhanced utilizing multiple cameras, e.g., to triangulate or otherwise determine location of a ball or other object. In one example, an optical map of a region of the course from a view of a fixed camera device may be utilized by a camera coordinate source to determine location of objects relative to known locations within the mapped region. For example, by comparing an image captured of an object to surrounding features in the image of known location, the approximate location of the object may be determined. Optical calculations such as those described above may be used to determine distance to enhance the accuracy of the location determination. In one embodiment, cameras are calibrated to a coordinate map of the course. The coordinate map may be a 3D point cloud map that the field of view of the camera is overlaid to determine location of balls. For example, the camera view and the 3D point cloud view, e.g., generated from LIDAR, may be aligned such that when personnel or a camera coordinate source utilizing computer vision (e.g., object detection, object recognition, or both), object tracking, or combination thereof identifies a location in the camera view, the coordinate or point in the 3D point cloud identifies the coordinate position corresponding to the location. The coordinate may also be translated into another coordinate system as described herein for use by the tracking system, data consumer clients 182, or as otherwise desired. Other sensor devices, such as radar devices 102 may be similarly calibrated. In one example, the coordinate map is collected using LIDAR; however, other mapping techniques may be used.

Coordinate sources may utilize laser data collected by laser devices 106 positioned around the golf course. The laser devices 106 may be utilized to measure distance of balls or other objects, generate coordinates of the ball or other objects, or both. Laser data may be analyzed to provide coordinates with respect to a from location, a final resting position, or both. The laser devices 106 may be operated be fully or partially automated, autonomous, or be operated by personnel. In some embodiments, laser devices 106, such as rangefinders associated with electronic communication devices that are together configured to determine coordinates of a targeted object may be used to confirm coordinates when an anomaly is present in automated coordinate identification. In another embodiments, such devices may be used when available. Laser devices 106 for collecting laser data for use in coordinate identification may typically be located at known locations, but in some instances one or more laser devices may be utilized in a mobile environment, e.g., utilizing RTK base stations or network, such as RTK based GPS, or other location methodologies with respect to the laser devices.

In various embodiments including a prediction generator 170, coordinate sources include the prediction generator 170. The prediction generator 170 may be configure to utilize ball flight data such comprising trajectory collected by radar devices 102 to predict a final resting position of the ball. The prediction generator 170 may be configured to predict ball flight, impact coordinates, bounce, roll, final resting position, or combination thereof. In some embodiments, the prediction generator 170 may additionally or alternatively utilize one or more of camera or laser data to determine trajectory, spin characteristics, or other parameters. Additionally or alternatively to any of the above, environmental data collected by environmental sensors, such as elevation, wind speed, wind direction, humidity, precipitation, or other environmental data may also be applied to final resting position predictions. The prediction generator 170 may include or be configured to obtain the applicable 3D course model comprising the surface model. The 3D course model may integrate or the prediction generator 170 may include or access the applicable coordinate map. In one example, the applicable course map 132 includes or integrates the 3D course model and coordinate map. In one example, the prediction generator 170 takes ball flight data, such as those collected by sensor devices, and applies AI to make an educated guess on final resting point. Location determinations of the ball in flight may be determined relative to a map of the course and the location of the sensor device measuring the ball flight data. In one example, the 3D course model or course map 132 may further includes or incorporate sensor device locations of the sensor devices supplying the ball flight data, e.g., provided by a setup position map, to identify locations, coordinates, ground characteristics, or combination thereof. In one embodiment, sensor devices supplying ball flight data may transmit location information with ball flight data. The prediction generator 170 may generate data elements to accompany the predicted coordinates when transmitted to the coordinate database 154, such as a timestamp corresponding to the predicted time the ball came to rest at the predicted coordinate, which may be derived from a time receipt with respect to when the sensor data used for the prediction was transmitted to the prediction generator 170 or a timestamp accompanying the same. Data elements may also include a geographic identifier. The geographic identifier may include a hole or other area of the golf course.

In one configuration, the prediction generator 170 may be similar in hardware, operation, and associated infrastructure as described in U.S. Pat. No. 18,238,234, filed Aug. 25, 2023, the contents of which are hereby incorporated by reference in their entirety. Briefly, a final resting position prediction system including a prediction generator 170 may be used to generate predictions with respect to the location of balls during golf play. The prediction generator 170 may be configured to output coordinates of predicted ball locations corresponding to a final resting position of a ball following a hit. The prediction generator 170 may utilize one or more prediction models to calculate a predicted bounce and roll behavior to predict final resting position coordinates. Predictions may consider various conditions of impact locations, such as topography, material, and properties thereof. Predicative analytics employing a prediction model that incorporates metadata measured with respect to ball physics and the course environment may be used to predict bounce and roll behavior. The prediction model may take measured ball impact physics, impact coordinates, and properties of the material corresponding to the impact coordinates together with historical shot data corresponding to the impact coordinates to predict bounce and roll behavior, final resting position, or both. Predictions models may be updated using data derived from comparison of actual and predicted bounce and roll behavior, final resting position, or both. The prediction generator 170 may utilize a course map 132 data that comprises a measured surface model specifying ground and object topography of coordinates of a golf course property. The surface model may comprise a 3D coordinate model, which may comprise a digital surface model measured by one or more techniques such as LIDAR, photogrammetry, or radar. It is to be appreciated that the prediction generator 170 may alternatively utilize course maps 132 of a course portion of a property for more limited application to predictive bounce and roll behavior for final resting position. Prediction models may incorporate physics, e.g., including ball impact physics variables, ball properties, and properties of ground and/or objects a ball impacts. Prediction models may further include one or more associated coefficients that modify prediction model terms, parameters, parameter estimates, or, otherwise, output. The coefficients may be applied to one or more terms or parameters of a prediction model. In one example, coefficients may include or alter terms, parameters, parameter estimates, or values corresponding to properties of impact materials. In some examples, coefficients include regression coefficients. PERSONNEL SOURCES

In some embodiments, coordinate sources include personnel sources that collect coordinates and transmit the coordinates to the coordinate identification unit 144 or coordinate database 154. Examples electronic communication devices 108 wherein personnel interact with digital maps displayed on the devices or enter coordinates of a ball location relative to the course using a printed coordinate map. For example, personnel may indicate ball location on a touch screen of the electronic communication device 108 displaying a digital map or enter ball coordinates into the electronic communication device determined by identifying the ball location on a grid or other coordinate map overlaying a map of the course. In another example, a laser rangefinder is operated by personnel to target balls wherein the laser rangefinder is keyed to the course to output the coordinates of the targeted balls. The laser rangefinder may be setup relative to the course at a known, stationary location such that the direction the laser is directed (e.g., using compass hardware such as one or more of a magnetometer, accelerometer, gyroscope, or mechanical location tracking) may be combined with the measured distance to obtain the coordinates of the ball. In another example, the laser rangefinder may operate in a mobile environment, e.g., utilizing RTK base stations or network, such as RTK based GPS, or other location methodologies with respect to determining the location of the laser rangefinder, such as one or more of locating, positioning, or proximity technology. For example, in one configuration, laser rangefinders or an associated or other electronic communication device 108 that receives laser measurements from the laser rangefinders, such as a computer including a processor and memory, is equipped with hardware, e.g., real time kinematic GPS, compatible with a location service infrastructure for tracking the location, position, or both of the laser rangefinder when a distance measurement is made to identify coordinates of a targeted ball or other object. The location services may include one or more of a global satellite constellation infrastructure or location network with respect to the golf course and may include radio receivers, transmitters, transceivers, antennas, UWB antennas, anchors, initiators, responders, cell towers, Wi-Fi access points, beacons, geobeacons, BLE gateways, or the like. In some embodiments, a location network includes or operatively communicates with external location/signal networks that utilize short range or long range location technologies, which may include signals of opportunity. According to one embodiment, laser rangefinders or an associated or other device that receives laser measurements from the laser rangefinders includes GPS hardware that identifies the coordinates of the laser rangefinder. This offers the ability to shoot a target location, e.g., ball, at a distance. Based on the GPS location, target angle compared to north (utilizing compass hardware), and the distance recorded from the ball location to the laser rangefinder, the coordinates of the ball location can be calculated. In some embodiments, mobile cameras or mobile LIDAR are calibrated to the course map 132 and employ location services or technologies. The location services or technologies may include GPS; GPS augmented with RTK base stations or networks, such as RTK based GPS; or other location methodologies with respect to improved GPS location accuracy.

In some embodiments, coordinates are transmitted with additional data elements, such as geographic identifiers corresponding to course, hole, or zone the corresponding to the coordinates, timestamps, or combination thereof.

Hole events will typically specify a player the hole event corresponds. However, in some instances, player identification is absent or incorrect. In one example, the event detection unit 142 or coordinate management unit 150 may be configured to access player tracking data, such as player tracking performed by the various sensor devices, to pair the geographic identifier accompanying the hole event with a tracked location of a player the corresponds to the timestamp of the hole event. Additionally or alternatively, the geographic identifier and timestamp may be used to identify a player group on the hole at the time corresponding to the time stamp. Coordinate locations and stroke counts for the players may be used to identify the player the hole event corresponds.

Coordinates may be accompanied by or associated with data elements comprising a geographic identifier, such as a hole number, and a timestamp corresponding to when the coordinate was obtained, which may correspond to the time the ball came or was predicted to come to rest at the coordinate. Additional data elements may also be included, such as tournament number. Identification of the coordinate source supplying the coordinates may also be transmitted with the coordinates or may be associated with the coordinates based on identification of the transmitting source. Coordinates may be in any coordinate system, such as grid systems, cartesian coordinate system, latitude-longitude, X-Y, geocentric coordinate system, global positions systems, or the like. In some embodiments, the tracking system 10 may be configured to translate coordinates between coordinate systems for use (e.g., utilizing the coordinate translator 152) in the operations of the of the tracking system 10 or data clients 182.

Further to the above, the tracking system 10 may include various sensor devices configured to automatically collect or predict ball location coordinates when the ball appears in their field of view. However, the coordinate data transmitted from the sensor devices may not identify what hole event the coordinate corresponds, such as which player, stroke, or both. In some examples, coordinates received from personnel sources 208a, 208b may also lack data identifying which hole event the coordinates correspond. Thus, the tracking system 10 may be configured to associate coordinates with hole events.

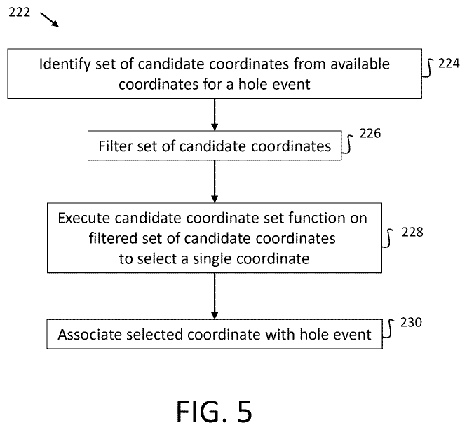

With further reference to FIG. 5, when a hole event is received or otherwise ready for association, the coordinate processor 156 may execute coordinate association 222.

Various methodologies may be used to initiate coordinate association 222. For example, the coordinate processor 156 may be configured to periodically query the event database 180 for hole events. In some embodiments, the time periods in which the coordinate processor 156 queries the event database 180 may be configurable. As another example, the event database 180 may be configured to transmit hole events to the coordinate processor 156 for association. In this or another example, a notification may be output to the coordinate processor 156 when a hole event is received and ready for coordinate association.

As introduced above, coordinates may be associated with data elements including a timestamp with respect to when the coordinates were collected. Timestamps may correspond to a time the ball or object arrived at or was predicted to arrive at the coordinate location. A geographic identifier may also be associated with the coordinate. Hole events may similarly be associated with data elements including a timestamp and a geographic identifier. Geographic identifiers may include a hole number, zone, or other location that is associated with the hole event by the source of the hole event or event database 180, e.g., based on location of the source of the hole event or signal parameters. In some embodiments, the source of a coordinate, coordinate identification unit 144, coordinate database 154, or coordinate processor 156 may execute a map query with respect to a coordinate to identify which hole or geographic area of the course the coordinate corresponds and associate the appropriate geographic identifier. For example, the geographic identifier may be determined by cross-referencing the coordinates with a coordinate map of the golf course, the sensor device location corresponding to the coordinate source, the sensor device location and its field of view, or by other suitable methodologies. For instance, hole events transmitted by a source of the hole event may include a data element comprising identification of the source of the hole event. The identification may be used to lookup the location of the source of the hole event. This location may then be used to associate a geographic identifier with the hole event, e.g., assigned hole, area or zone of hole, or field of view of the sensor device. For example, locations of sensor devices during the tournament or round may be stored and available for lookup, e.g., in the map database 130. In one example, data elements include GPS or other coordinates of the source of the hole event when the hole event was captured or transmitted. These coordinates may be cross-referenced with a coordinate map of the course to determine the location of the source of the hole event and used to associate a geographic identifier with the hole event. Coordinates may also be associated with a coordinate type data element that specifies the sensor device source of the coordinate, e.g., radar device 102, camera device 104, laser device 106, prediction generator 170, laser rangefinder associated with an electronic communication device 108, an electronic communication device 108 including map interaction, or other source. It is to be appreciated that the types and number of types of coordinate sources may be increased, decreased, or otherwise modified as desired. Thus, a sensor device or sensor data collected by the sensor device may be used to one or more of track players, identify events, or identify coordination. Similar to that described above with respect to sources of the hole events, coordinates may be transmitted with a coordinate source identifier that specifies the type of coordinate source or that may be looked up to identify the type of coordinate source by its identifier.

When a hole event is ready for coordinate association, the tracking module 120 may be configured to execute a coordinate association method 222. This may include identification of a set of candidate coordinates from available coordinates for a hole event 224. For example, the coordinate processor 156 may search the coordinate database 154 and identify candidate coordinates for the hole event 224. To identify an appropriate set of candidate coordinates, the coordinate processor 156 may geo-temporally filter the available coordinates. In one embodiment, the coordinate processor 156 may retry the search when candidates are not present or when additional candidates may be delayed. In one example, retry attempts may be a configurable N number of a times at a configurable interval until success.

Geo-temporally filtering the available coordinates may utilize the geographic identifiers of the hole event and the available coordinates to geographically filter the available coordinates and the timestamps of the hole event and available coordinates to temporally filter the available coordinates.

To geographically filter the available coordinates, the coordinate processor 156 may select coordinates associated with geographic identifiers corresponding to the geographic identifier of the hole event. For example, the geographic identifier may specify a hole number, area of the golf course, zone of a hole, or the like. In some configurations, a range or distance from the geographic identifier of the hole event may be further applied, which may consider the hole event type, historical shot resting positions on similar strokes, or combination thereof.

To temporally filter the coordinates, the coordinate processor 156 may apply a time window around or after the timestamp of the hole event and identifies coordinates within the time window as potential candidate coordinates. In one embodiment, the window includes a waiting period. For instance, the coordinate processor 156 may apply a waiting period or add-on period between the timestamps of the hole event and the coordinates. Waiting periods for instance may consider hole event type. For example, a hole event corresponding to a tee shot may be given a waiting period of about 6 seconds, a hole event corresponding to a putt may be given a shorter waiting period, and hole events corresponding to other shots may be given a waiting period somewhere therebetween. In one example, waiting periods may be configurable to account for different hole characteristics, e.g., tee shot on par 3 holes may be given a shorter waiting period than for par 4 or par 5 holes. In one embodiment, application of a time window includes looking for coordinate timestamps within +/−N seconds from the timestamp of the hole event or, if included, the end of the waiting period. In one configuration, the time window may be offset such that the window includes a longer time period after the timestamp or waiting period than prior. Various time windows may be applied. In one example, the time window applied may be at least partially determined by the hole event type. For instance, a longer window or waiting period following a hole event timestamp may be applied to tee shots or first strokes than to an approach or second stroke. Time windows may be configurable to account for different hole characteristics, e.g., tee shots on par 4 or par 5 holes may be given a longer time window tee shots on par 3 holes.

In an embodiment of the coordinate association method 222, the geographic identifiers comprise hole numbers and the coordinate processor 156 is configured to identify a set of candidate coordinates associated with the same hole number as the hole event within the time window with respect to the timestamp of the hole event.

The coordinate association method 222 may further include filtering the set of candidate coordinates 226. For example, the coordinate processor 156 may further filter the identified set of candidate coordinates. This may include applying one or more filters. Various filters may be used, and the number and type of filters may be dynamic, configurable to the hole, or both. Example filters may include cascading filters wherein the selection of a candidate coordinate depends on the selection or filtering of another coordinate. In another or further example, filters may include excluding coordinates that are already associated with a hole event. In a further or another example, filters may be distance related such as excluding coordinates that are within or outside a distance from the tee or hole. This may include consideration of the hole event type and one or both of hole characteristics or historical play on the hole. For example, if a hole event type is a second shot on a par 5, historical shot data may be utilized to determine a distance range from the tee to exclude coordinates. In another or further example to any of the above, filters may be temporally based. For example, coordinates having timestamps outside a 5, 10, 15, or 20 second window of the time stamp for the hole event may be filtered out. In another or further example to any of the above, filters may consider a from location, which may be an associated data element of the hole event or derived from the stroke count. For example, if the hole event type is a tee shot on a 500 yard hole that players have historically never hit the tee shot more than 320 yards from the hole, coordinates within 150 yards of the pin may be excluded and coordinates within 350 yards may be retained for further filtering. Filters may consider the player the hole event relates and the previous hole event of the player. For instance, if the hole event is with respect to the player having a shot to coordinate on the previous shot, coordinates further from the pin than the previous to coordinate may be filtered out. Similarly, if the hole event has an associated shot from coordinate, coordinates further from the pin may be filtered out. Filters may also consider a shot from coordinate associated with the previous hole event of the player. For example, predicted coordinates may use sensor data, such as radar data, that includes from coordinates. The predicted coordinates having from coordinates the same as or within N distance of the from coordinates of the previous hole event may be used as a filter to filter out coordinates beyond N distance from the predicted coordinates.

In some embodiments, coordinate association includes filtering coordinates to obtain a single coordinate (set of coordinates) for each available coordinate source type. This may include using coordinate proximity to the predicted coordinates having a timestamp closest in time to the timestamp of the hole event to identify at maximum a single coordinate (set of coordinates) for each available coordinate type. Thereafter, or in another example, filtering includes grouping the candidate coordinates by coordinate source type and retaining the candidate coordinate (set of coordinates) for each group that is closest in time to the timestamp of the hole event. This may be performed as an initial filtering step or following another filtering step. Thereafter, functions may be called to put the strokes for each hole in order to analyze each candidate coordinate and determine which one aligns best with surrounding strokes and should be treated as the “true” shot to coordinate. In one embodiment, the criteria for determining which candidate should be designated as the “true” coordinate is configurable on a per hole basis. In one example, hierarchical rules may additionally or alternatively be applied. For instance, coordinates captured manually by personnel, e.g., using a laser rangefinder or electronic communication device with an interactive map, may be set to always take precedence on particular hole events, such as shots not from a tee or that were holed, in which case tee or pin coordinates, e.g., obtained from the setup position map, take precedence.

In the illustrated coordinate association method 222, the method 222 includes executing a candidate coordinate set function on the filtered set of candidate coordinates to select a single coordinate (set of coordinates) with respect to a location on the course 228. For example, the coordinate processor 156 may execute a candidate coordinate set function on the filtered candidate coordinates to associate with the hole event 230. In one example, the function may include applying hierarchy rules to the filtered set of coordinates based on coordinate type corresponding to the coordinate source of the particular coordinates. The hierarchy rules may be static or dynamic. The choice of hierarchy rules may be determined based on historical experience, which may include experience with equipment, users, specific course, specific hole, or the like. In various embodiments, the hierarchy rules may be configurable down to the course or hole level. For example, a hole on a course may have different applicable hierarchy rules than another hole on the same course. While various combinations of hierarchy rules may be applied, some hierarchy rules may consider coordinate type, which corresponds to the type of coordinate source that collected the coordinates. For instance, an example rule may include selecting coordinate types from sources with direct human interaction over those without human interaction with respect to active collection of coordinates. For example, coordinate source types manually collected may be selected over coordinates types corresponding to coordinate sources that collect coordinates without direct human intervention, e.g., fully or partially automated or autonomous sensor devices, such as radar devices 102 or camera devices 104. Manual coordinate types may typically include an associated data element that identifies the hole event the coordinates correspond, thus, in some configurations, the coordinate processor 156 may automatically associate these coordinate types with the associated hole event. For instance, in one example, the coordinate processor 156 may automatically include the associated coordinates in the filtered set of candidate coordinates for application of the candidate coordinate set function. In another example, the coordinate processor 156 may automatically associate the coordinates with the hole event and forego candidate identification, filtering, and the set function. Another example hierarchy rule may include selecting laser rangefinder coordinate type over camera coordinate type when the distance of the coordinates for the camera coordinate type is greater than N inches from the coordinate of the laser rangefinder coordinate type. This may be favored when laser rangefinder coordinate types have higher accuracy that camera coordinate types. As another example, hierarchy rules may include selecting camera coordinate types over radar and prediction coordinate types. In some embodiments, prediction coordinate types may be selected over radar coordinate types. As there may be multiple coordinates of the same coordinate type, an example hierarchy rule may include selecting the coordinates that are most recent or last in time for each coordinate type to associate with the hole event and then further filtering or applying a function thereafter to obtain the “true” shot to coordinate as described above and elsewhere herein. A shot from coordinate may also be determined if not present.

In various embodiments, as introduced above, when the hole event type is in the pin, the coordinate processor 156 may be configured to associate pin coordinates for the appropriate hole. When the hole event type is from the tee, the coordinate processor 156 may associate coordinates of the tee, which may be provided as available coordinates in the coordinate database 154. For instance, the coordinates of tees and pins may be collected prior to or during play and be made available for association by the coordinate processor 156 for appropriate hole events, e.g., coordinates may be extracted from a setup position map. In one example, data elements for tee and pin coordinates are associated with coordinate type tee and pin, respectively, and the hole. Thus, the coordinate processor 156 may search the coordinate database 154 for coordinate type tee or pin for the appropriate hole event type on the corresponding hole. In one embodiment, when hole event type is stroke from tee, the coordinate processor 156 may automatically associate tee coordinates with the hole event. When hole event type is in the pin, the coordinate processor 156 may automatically associate pin coordinates with the hole event. This association may be performed with or without executing candidate association steps described with respect to FIG. 5.

For each hole event, the coordinate processor 156 may associate coordinates corresponding to a shot from location and a shot to location. In one configuration, the shot from location may be determined in a manner similar to that described above with respect to associating shot to coordinates wherein the geographic identifier and timestamp of the hole event is used to geo-temporally filter movement from type coordinates on the hole with timestamps within a configurable time window of the hole event. In a further or another embodiment, the coordinate processor 156 associates coordinates with hole events sequentially with respect to stroke count such that shot from coordinate for a stroke hole event for a player is the shot to coordinate for the previous stroke hole event for the player.

After a “final” or “true” coordinate has been associated with the hole event 230, this detailed scoring data may be transmitted to the scoring database 162 for use by various data consumers such as applications, websites, data clients 182, data platforms, television broadcasts, or the like. In some embodiments, further processing of the hole event together with the associated coordinates may be performed. For example, distances may be calculated between the shot from and shot to coordinates, shot locations with respect to zone may be determined, updated, or checked based on the coordinates, or other processing such as processing related to score evaluation or statistics generation.

In some embodiments, the process of FIG. 5 further includes executing an update function that reviews hole events and associated coordinates to identify hole events with multiple associated coordinates. This may occur when preliminary coordinates are associated with hole events or when the coordinate processor 156 executes coordinate association 222 for a hole event more than once, e.g., based on new data or changes in data. The update engine 158 may compare coordinates associated with the hole events stored in the scoring database 162 to a coordinate associated with the hole event via a current or subsequent operation of the coordinate processor 156. The update engine 158 may update the coordinates if the previously recorded coordinates are different. Additionally or alternatively, the update engine 158 may mark differing coordinates for further review, generate a notification that coordinates have been updated, or both. In one example, an update, notification, or both is further transmitted to data consumers that have accessed or otherwise been provided with the previously recorded coordinates with respect to the hole event.

As introduced above and elsewhere herein, fixed sensor devices, mobile sensor devices, or both may be setup on a specified geographical area comprising a golf course. In some embodiments, the sensor devices may be calibrated to the course map 132. For example, the course map 132 may include or incorporate a point cloud captured by LIDAR mapping, defined in or translatable to a coordinate system to provide a coordinate map, as described herein. In some embodiments, sensor devices may be continuously recalibrated as needed throughout an event based on map data 131 provided.

Sensor devices may include those described herein, such as camera devices 104, laser devices 106 (e.g., LIDAR devices, laser rangefinder devices), radar devices 102, or combination thereof. Camera devices 104 may be fixed, mobile, or both. For example, fixed a camera devices 104 may be positioned around each tee box 194, fairway 190, and green 191. The location of the camera device 104, such as GPS location, may be used to calibrate the field of view, which may also be referred to as sensor view, to the course map 132. Measured reference points may be determined and set within the sensor view for calibration. In one configuration, one or more mobile camera devices 104 may also be present to capture locations outside the field of view of fixed camera devices or to enhance location and movement detection accuracy, e.g., using trilateration or triangulation techniques. The mobile cameras may utilize location methodologies, such as those described herein, e.g., real time kinematic (RTK) based GPS, to establish location of the camera device 104 for automated calibration of the field of view to the coordinate map in order to determine location coordinates of tracked players and objects. LIDAR units may be arranged at similar locations as described with respect to cameras and, in some examples, may include mobile LIDAR. In one example, radar devices 102 configured with ground to air doppler radar technology may be positioned by tee boxes 194 and greens 191. The sensor network 100 may typically include radar devices 102 at fixed locations, such as tees boxes 194 and greens 191. In one configuration, mobile radar devices 102 may also be used to capture play outside the field of view of fixed radar devices 102 or to enhance accuracy of location and movement detection, e.g., using trilateration or triangulation techniques. In the above or another example, camera devices 104 may be positioned by tee boxes 194, fairways 190, and greens 191. The mobile radar devices 102 may utilize location methodologies, such as those described herein, e.g., RTK based GPS, to establish location of the unit for automated calibration of the field of view to the coordinate map in order to determine location coordinates of tracked players and objects.

In some embodiments, one or more sensor devices may be configured for multiple fields of view. For example, sensor devices may be mounted with actuation hardware configured to move the sensor device to change the field of view. Movable sensor devices may be calibrated to the course map 132 with respect to the multiple fields of view such that coordinates may be determined within the multiple fields of view. In one example, the actuation hardware comprises automated robotics configured to automatically move a sensor to change field to track objects. In this or another example, the tracking system 10 includes administrative tools that allow users to access actuation hardware to remotely change field of view of one or more sensor devices.

Course map 132 may comprise a coordinate map that includes or that is keyed to coordinates of a coordinate system, which may include a cartesian, geodetic, geocentric, latitude-longitude, such as GPS, or proprietary system. Coordinate maps may be keyed by overlaying or otherwise calibrating the course map 132 to coordinates such that locations on the map may align with corresponding coordinates in one or more coordinate systems. In one example, a coordinate map comprises a point cloud wherein the points are defined within a cartesian space, keyed to another coordinate system, or both. Additionally or alternatively, points or coordinates in the coordinate map may be further keyed or otherwise translatable to another coordinate system, such as via the coordinate translator 152 described herein for use by the tracking module 120, data consumer clients 182, or as otherwise desired.

The sensor devices such as radar devices 102, e.g., doppler radar, camera devices 104, or laser devices 106, e.g., LIDAR or rangefinders, may be calibrated to course maps 132 for tracking players, balls, or other objects during play. For example, sensor calibration may be performed to match sensor field of view to the course map 132. As a result, sensor views may be aligned with the course map 132 and coordinates of players, balls, and other objects may be identified. In some embodiments, the coordinate map is a 3D map and coordinates may include a vertical position identifier together or separately from a horizontal position. Utilizing various coordinate systems, detailed data may be derived from the coordinates for use by the tracking module 120 and data consumer clients 182. In one embodiment, one or more sensor devices are calibrated to map coordinates that are keyed to one or more coordinate system such that each coordinate location pairs with a coordinate location of another coordinate system. When the tracking module 120 analyzes the sensor data within the sensor view together with the course map 132, e.g., point cloud captured using LIDAR, following calibration, the sensor data and course map 132 line up such that when the tracking module 120 detects a ball, e.g., via automated object detection, or when a user interacts with the sensor data (e.g., within a display of an electronic communication device), the coordinates or point in the course map 132 can be converted to an actual location of the golf ball, e.g., the latitude-longitude coordinates. For example, the camera view and the point cloud view may be aligned during calibration such that when a user, laser rangefinder, or system component, e.g., tracking software utilizing object tracking, identification, or recognition, identify a location in the camera view, the point in the point cloud identifies the coordinates. The coordinates may also have associated detailed data, such as course zone, hole number, ground surface type, ground surface characteristics, coordinates in another coordinate system, or other detailed data.

The tracking module 120 may be configured to record and analyze sensor data for identification and tracking operations. Example sensor data recorded and analyzed by the tracking module 120 may include player movement, e.g., gait, player recognition, e.g., clothing color and type, specific player's ball recognition, e.g., based on hitting order or last known ball position, ball movement, or club movement. Sensor devices may be used to track live location of player addressing ball, ball hit, ball impact, and trace of the ball when in view. Camera devices 104, LIDAR, or both may be used to track players tee to green.

The sensor data processor 140 or event detection unit 142 may be configured with artificial intelligence to utilize sensor data to automatically identify objects around the golf course. For example, the tracking module 120 may be configured with computer vision (e.g., object detection, object recognition, or both), LIDAR, or both computer vision and LIDAR. In this or another embodiment, the tracking module 120 may be configured with artificial intelligence to utilize sensor data to automatically identify players for player tracking around the golf course. For example, the tracking module 120 may be configured with object detection, or more specifically person detection, to identify players in video image data captured by camera devices.

Computer vision training utilizing photos, video, or other identifying images or information with respect to particular players or objects, e.g., balls, may be used. In one embodiment, person detection may utilize LIDAR, e.g., 3D LIDAR, in addition to or instead of camera images. For instance, the tracking module 120 may be trained to identify and track players in LIDAR images. When implementing person detection, the tracking module 120 may utilize multiple methods, such as facial recognition, body recognition, gait recognition, shape recognition, clothing recognition, or combination.

In one embodiment, person detection training may include labeling a player in images captured at the first tee box 194 or otherwise to reinforce previous training or assist the person detection with respect to identification of a player. For example, if needed, personnel may assist in determining who a player is on the first tee box 194 or otherwise by labeling the player in images. Additionally or alternatively, automated training for person detection may be used. For example, the tracking module 120 may be populated with playing order of players and identification of each player may be automated by combining playing order at the first tee box 194 with the players after the player has hit their first shot. Thus, if the tracking module 120 is initially unable to identify a player from video, balls hit off the first tee box 194 may be tracked relative to each player and using hitting order, the tracking module 120 or sensor device may identify the player. Determining when a ball is hit off the tee may be determined by analysis of the camera images, LIDAR images, radar, or other sensor data. In some implementations, the tracking module 120 may create a data set of an identified player overtime to improve its ability to identify the player in the future, during the same or later tournaments.

In addition to or instead of person detection, other player identification methodologies can be used. In one embodiment, players carry or wear an optical, electromagnetic, or reflective maker identifiable in the sensor data that uniquely identifies the player. In one embodiment, the tracking module 120 may utilize individualized GPS sensors, e.g., GPS trackers 109, that may be worn or carried by players, caddies, or course personnel in order to identify players and track location of the player utilizing GPS coordinates mapped to the course.

Player identification may be used in conjunction with other sensor data, such as radar data, to tie a ball trace to a specific player. The player identification may identify where the player is, and the tracking module 120 may then tie the from location of the trace to the location of the automatically identified player.

Implementing player detection from the sensor data, the tracking module 120 may identify players and keep track of their location one each hole. In one embodiment, the tracking module 120 may be configured to automatically create events for players using the identified player and further detection of player or object movement with respect to the player or their vicinity. For instance, cameras, LIDAR, radar, or combination thereof may detect ball movement in proximity to the coordinates of the player or swing movement with respect to the player and create a ball hit event with respect to the player.

In one example, the tracking module 120 implements machine or computer vision camera devices 104 configured for optical recognition. For instance, the tracking module 120 may utilize facial recognition, body recognition, gait recognition, clothing recognition, ball/shape recognition, or the like to identify participants and balls to thereby pair location with player and the player's ball.

The tracking module 120 may be configured to distinguish between and detect movement from 3D objects such humans, animals, golf balls, and other environmental objects. The tracking module 120 may be specifically configured to identify and track movement in the sensor data of a golf ball or human, e.g., player, and determine its trajectory and location data. Trajectory and location data may include, but is not limited to timestamps, ball in motion in the air, ball in motion on the ground, ball location from landing to resting position on the green and fairways (1^{st} cut), prediction of ball position in 2^{nd} cut and deeper rough, and player location on course or on the range. Once a player and ball are detected within a sensor device view, the tracking module 120 may analyze data about the object, which may include movement, location, other objects around the object, or other object related data. The related data may be used to create automated events used by the tracking module 120 to trigger one or more of updates, notifications, or actions to be taken within the tracking module 120 or by data clients 182. In further embodiments, player identification together with other related sensor data may be used by the tracking module 120 to generate automated events such as updates, notifications, or actions to be taken by the tracking module 120 or data clients 182. For example, player identification may be used by the tracking module 120 to identify when a player is near their ball to create various automated events that trigger notifications, updates, actions, or combination thereof. Other related sensor data may include location of the identified player throughout the round. Related data may additionally or alternatively include detection of movement of the player or objects.

Events may include the player entering a defined zone, such as a tee box 194, approaching their ball, addressing their ball, or hitting their ball. Player location may be determined from player tracking, e.g., via camera devices 104 or GPS trackers 109. Events may include ball impact, ball at rest, or ball in hole. Events may relate to player actions such as approaching tee box 194, in tee box 194, addressing a ball, approaching ball, standing over a ball, standing over another player's ball, approaching green, putting, walking, interacting with caddie, interacting with another player, interacting with fans, interacting with marshal, interacting with rules official, or as otherwise desired. In one example, sensor data may be used to detect events for addressing ball, hit ball, ball flight, ball impact, ball at rest, ball in hole, or other events such as sub events (e.g., ball at apex, ball rolling, etc.), preceding events (e.g., player approaching ball), subsequent events (e.g., player walking to ball at rest location), or events in between (e.g., player swinging club, ball traveling out of sensor views, ball traveling out of bounds, ball traveling out of field of view of primary TV broadcast camera, ball traveling into field of view of particular TV broadcast camera). The events may trigger actions such as display of the player's location or both the location and event on onsite digital signage, transmit updates or notifications of the same to digital platforms such as onsite player tracker applications or APIs available to data clients 182, which may include television broadcasts, update tracking system databases, transmit notifications to ground personnel to look for ball in an specified area, or change a sensor's field of view to capture subsequent play.

In one example, sensor data from camera devices 104, radar devices 102, GPS trackers 109, or combination thereof may cause an addressing the ball event when a player is detected addressing their ball or a player approaching the ball event when a player is detected approaching their ball. The event may include player approaching their ball or in position by their ball and include additional data such as ball location and shot number. The event may trigger automated tasks such as notifications, updates, actions, or combinations thereof. The event may trigger a notification to television broadcasts or cause tracking data to be updated on fan enhancement platforms such as onsite signage or player tracking applications. A notification of the event may be sent to scoring personnel or automated scoring sensors to assist in capturing a subsequent stroke hole event. The event may trigger a notification of the event to broadcast television clients 182. The event may trigger switching to live broadcast camera feed of the player for presentation on signage or television broadcasts. In one example, the event may trigger a recording of the subsequent shot to be associated with the player, which may further include associating related information, such as shot location, hole, stroke count, or combination thereof, for web access, later recall for television broadcasts, highlights, presentation on signage, or other use.

In some instances, anomalies may be present in the sensor data or the identification or tracking data derived therefrom. Accordingly, the tracking module 120 may be configured with rules to assist in one or more of identifying, reviewing, or editing anomalies in the data collected or interpretation thereof. For example, sensor data collected by one or more of a camera device 102, radar device 102, or laser device 106 may use player and ball detection to detect a player standing over another player's ball. This may generate an addressing or approaching another player's ball event. The event may trigger a notification to tracking system administrators to review the accuracy of the ball location, player identification, or both to ensure accurate identification is established and maintained. If the identification is inaccurate, administrative personnel may assist the tracking module 120 to accurately identify the player and ball, which may include retraining or otherwise setting the tracking module 120 as to the player or ball.

Some configurations of the tracking system 10 may also identify and track a player's ball wherein movement of the player's ball may automatically cause the tracking module 120 to create a ball hit event, which may be associated with the tracked player. In one embodiment, the ball hit event is recorded as a hole event, e.g., a stroke. The hole event may be transmitted to one or both of the event database 180 for coordinate association or the scoring database 162 for score tracking, which may include further review and confirmation. In a further embodiment, a ball hit event may be handled as a preliminary hole event that the tracking module 120 further analyzes utilizing additional sensor data, such as player going to and hitting the identified ball on their subsequent shot, or from receipt of a hole event entry from personnel that includes a corresponding timestamp to confirm the hole event. The tracking module 120 may be configured to apply rules for confirming a preliminary hole event defining data for confirming particular events. In one example, radar device 102 or analysis of radar data generated by the radar device 102 may detect a ball hit from the coordinates of the identified player's ball or in proximity to the identified player's coordinates at the time the ball is detected to have or the player is detected to have swung at the ball and a stroke hole event may be confirmed by detection of the player swinging a golf club at the location of the ball at the time the ball is detected to have been hit from the from location, e.g., beginning of ball trace, or detection of the presence of the ball followed by the absence of the ball from its coordinates corresponding to the time the ball was detected as being hit from the location.

The triggers may therefore be used to allow fans to follow a particular player, television broadcast to direct cameras to a player's location, update websites providing live game casts that track players and events, direct operations of ground personnel for improved management and tracking of play, direct operations of system administrators to ensure accurate identification is established and maintained throughout the round, or update or improve operation of the tracking system 10, which may include automated dynamic modification of sensor fields of view to events.

In one example of an operation of the tracking module 120, object and person detection is employed using sensor data collected by sensor A and sensor B. Sensor A and sensor B may have overlapping fields of view calibrated to the course map 132, as described herein, and may comprise camera sensors, LIDAR sensors, or combination thereof. Using person detection, the tracking module 120 may identify player A and track player A. Player A may be identified by hitting order, aspects of player A such as clothing, build, face, gait, or by GPS location or unique marker worn by player A detectable by sensor A or other sensor. The tracking module 120, using sensor A sensor data, detects player A approaching coordinate X, near coordinate X₁, which is the actual or predicted location (or allowable range) of player A's ball following a previous hit, e.g., as determined by coordinate association. This may result in the tracking module 120 generating an approaching the ball event. Sensor data collected by sensor C, which may be one or more of a camera, LIDAR, or radar sensor, is used to detect swing movement or club movement at coordinate X, corresponding to player A's location at time T₁ or within time period T₁-T₂. One or more of sensor A, sensor B, or sensor C detects ball movement at or traced back to coordinate X₁ at time T₁₊₁, within period T₁-T₂, or at a time Tₓ corresponding to an expected time frame for a ball strike based on the detected swing movement or club movement. The tracking module 120 may then tie the location of coordinate X of player A, the location of the swing or club movement, with ball movement originating from coordinate X₁ as being player A's ball. This reinforces the identity of the ball as being player A's ball if previously known or, if unknown, may be used to re-identify the ball as player A's ball. In one example, the tracking module 120 may generate a ball hit event for player A. This may trigger the event to be transmitted to the event database 180 for coordinate association or the scoring database 162 for score tracking, which may include further review and confirmation. In one example, sensor C is a radar device and collects ball flight parameters that the tracking module 120 uses to predict a resting location for the ball. Sensor B may look to the predicted coordinate to confirm the coordinate or otherwise identify the ball at a coordinate for coordinate association. Events for impact and rest may be generated. The coordinates and times (timestamp) of these events may be associated with the predicted coordinates and times or otherwise in the coordinate association steps for event detection and used to identify or reinforce the identity of player A's ball for future shots, which may also include identification or reinforcement of the identity of player A as the player detected to hit the ball from its location or output and notification for review of accuracy.

In various embodiments, the tracking system 10 includes a scoring module 164 configured to monitor scoring data that is received into the tracking system 10. The scoring module 164 may include an application executed by the tracking system 10 configured to analyze scoring data, event data, or both in the scoring database 162 or event database 180 and identify anomalies. Additionally or alternatively, the scoring module 164 may be configured to communicate with the tracking module 120 to receive event data triggering notifications to the scoring module 164 with respect to player, ball, or object anomalies. In an above or another example, the scoring module 164 may be configured to communicate with the prediction generator 170, coordinate processor 156, or both to receive notifications with respect to capturing coordinates. Thus, the scoring module 164 may be configured to provide users notifications of anomalies or other events so the users may take action to address the anomalies or obtain coordinates in an otherwise autonomous tracking environment. The anomalies may relate to anomalous hole events, ball locations, player locations, ball identification, player identification, or other anomalies.

Scoring data may be received from automated analysis of sensor data identifying hole events, personnel interaction with electronic communication devices 108 identifying hole events, or other sources. As scoring data is being collected, the scoring module 164 is configured with an ability to make any modifications that are necessary and add missing data as appropriate. For instance, the scoring module 164 may be configured to provide access to scoring data to allow users to verify all or a portion of the scoring data, make modifications to existing data, enter missing data based on their own visual observations, or combination thereof. The scoring module 164 may be further configured to analyze scoring data to identify anomalies. For example, the scoring module 164 may be configured with predefined rules created to identify or assist a user of the scoring module 164 in identification of anomalies in the scoring data that should be reviewed.

In some embodiments, users may execute or access the scoring module 164 via electronic communication devices 108. The electronic communication devices 108 may comprise handheld electronic communication devices 108. In one example, the electronic communication devices 108 comprise display screens for displaying notifications. The electronic communication devices 108 may be similar to the those described above with respect to map interaction wherein personnel interact with digital maps on the device or printed maps of a hole, GPS location, or laser rangefinder targeting for communication of coordinates via the electronic communication device 108 to the coordinate database 170. For example, users may indicate ball location on a touch screen of the electronic communication device 108 displaying a digital map or enter ball coordinates into the electronic communication device 108 determined by identifying the ball location on a grid or other coordinate map overlaying a map of the course. Additionally or alternatively, the electronic communication device 108 may include or communicate with a laser rangefinder that a user may use to target an object to identify the object's coordinates via the course map 132.

The rules may include notifications directed to the user that a specific scoring data needs to be reviewed, modified, or entered. Notifications may provide the user information regarding a type of anomaly in the data, a player the anomaly relates to, a stroke the anomaly relates to, a hole the anomaly relates to, or combination thereof. The rules may also include notification to users in advance, predicting a scenario may occur based on identification of a location in the sensor data. As an example, when the tracking module 120 receives a prediction from the prediction generator 170 that a ball will come to rest outside of a sensor's viewing angle, an event may be created that triggers a notification to have a user manually collect the location of that ball by selecting a location on a map or from a distance with a laser rangefinder or other electronic communication device 108 or via another method or take another action on the electronic communication device 108 to approve the predicted location. As another example, notifications may be triggered to users to access actuator hardware or to automated robotics of a sensor to change a sensor's field of view due to balls or other objects consistently traveling or being outside a current field of view or to capture location coordinates of a ball or other object that has or is predicted to travel outside the field of view of the sensor. As yet another example, when the tracking module 120 determines that a hit ball will likely hit an obstacle, such as a tree or a building, an event may be generated that triggers a notification to scoring module 164 for an alert that the ball may end up in an unexpected location.

For example, the scoring module 164 may be configured to interact with GPS and laser rangefinder hardware, e.g., electronic communication devices 108 including GPS location and laser rangefinder capabilities, giving the user the ability to provide accurate coordinate location to address anomalies in the data derived from on-course sensors or in areas the sensors cannot detect. For example, an electronic communication device 108 associated with a fixed or mobile laser rangefinder having location capabilities, such as GPS location, which may include RTK based GPS, may be used for accurate coordinate location identification. A rule may trigger a notification to the electronic communication device 108 that alerts the user of an anomaly in the data's location and the user may use the hardware to record an accurate location. For example, the electronic communication device 108 may be configured with GPS functionality and execute or access operation of the scoring module 164. Using the GPS, the scoring module 164 knows the latitude-longitude location of the electronic communication device 108 or laser rangefinder associated therewith. The laser rangefinder is therefore operable to allow the user to target a location at a distance to identify a coordinate corresponding to a player, ball, or other object in which a notification alerts a user to review or identify its location. The laser rangefinder may have a compass or be setup to track targeting direction, e.g., as described above. Based on the target angle compared to north and the distance recorded from the object location to the laser rangefinder, the latitude-longitude coordinates of the ball location can be calculated by the scoring module 164 and the anomalous or missing coordinate may be updated. In one configuration, the electronic communication device 108 comprises a computer, such as a tablet, that the user may utilize to validate a coordinate on a displayed map where the recorded location is. In a further configuration, the map may also display coordinates obtained from other sensors or other data to aid the user of the tablet to capture data the location data. In some embodiments, the coordinates may be further translated using the coordinate translator 152. As described above, some implementations may utilize hardware including electronic communication devices 108 with interactive maps. As also described above, the GPS location may be augmented to improve accuracy of the coordinates of the laser rangefinder with, for example, WAAS (Wide Area Augmentation System), Differential GPS (DGPS), e.g., Global Differential GPS (GDGPS), real time kinematic (RTK), Continuously Operating Reference Stations (CORS), Signals of Opportunity (SOP)-based or augmented navigation, UWB, LTE, cellular, radio, television, Wi-Fi, other satellite signals, or the like. In one implementation, survey quality GPS antennas may be positioned on the course to augment the GPS accuracy with respect to the laser rangefinder or electronic communication device 108.

In one embodiment, radar devices 102 may detect a golf ball in flight. The tracking system 10 may then utilize the radar to analyze the golf ball's trajectory and predict the flight path/trace, impact position, and resting position coordinates of the golf ball with reference to the map data 131. The tracking system 10 may then cross-reference the predicted coordinates with the field of view of relevant sensors to determine if the coordinates are within the field of view for sensors implicated in tracking the ball and collect actual location information from those sensors. If not, the tracking system 10 may send a notification to an electronic communication device 108 operated by personnel to otherwise obtain coordinates for the ball, e.g., via utilization of laser rangefinder to sight the ball to obtain its coordinates, interacting with a digital map by indicating the ball's location on a map displayed on a display screen of the electronic communication device 108 to mark its location, or reference a map to obtain the coordinates and enter the coordinates into the electronic communication devices 108. In this or another embodiment, the tracking system 10 or scoring module 164 thereof may send commands to autonomous sensors on where to look for the ball. The tracking system 10 or scoring module 164 thereof may send a notification to nearby broadcast cameras on where to look for the ball. The tracking system 10 or scoring module 164 thereof may additionally or alternatively also cross-reference the location and coordinate data from multiple sensors in order to confirm the accuracy of the golf ball location.

In one embodiment, the actuator hardware for moving a sensor and hence the field of view includes a pan/tilt mechanism configured to aim the sensor. The pan/tilt mechanism includes gears, shafts, and motors operable to pan and tilt the sensor with no throwback movement of the sensor after a positioning movement is complete. The pan/tilt mechanism may include a controller configured to control the operations of the pan/tilt mechanism to move the sensor. The pan/tilt mechanism may include a communication port configured to communicate with local or remote communication devices over one or more networks. Operation of a pan head of the pan/tilt mechanism may be manually input and affected by user input, which may be provided remotely via remote communication with the controller. In one configuration, the controller is configured to be accessed by the communication devices for receiving control instructions, e.g., from anywhere in the world with proper access to network resources, such as via a secure connection. In any of the above or a further embodiment, the pan/tilt mechanism is configured for to automated control based on collected sensor data. For example, the tracking module 120 may analyze sensor data as described above and automatically control the pan/tilt mechanism to change the field of view of the sensor to track players, balls, or objects that are outside the field of view or are predicted to be outside the field of view (e.g., based on trajectory data).

With continued reference to FIGS. 1-5, in various embodiments, the tracking system 10 includes a hardware and logic allowing for collection and management of tracking data from various sensors to support scoring and statistical information for golf events. The tracking system 10 may be configured for minimal human interaction to collect the tracking data using the sensors. It is to be appreciated that the below description may be further applicable to the embodiments and examples described above. That is, the features and operations described herein are not to be read in isolation as the tracking system 10 is capable of many configurations and combinations of components and operations. Similarly, the tracking system 10 may be modified to include fewer or additional, different, or alternative features, such as any of those described above.

As introduced above, map data 131 with respect to the course may be collected to generate various maps, such as course maps 132, to support operations of the tracking system 10. Course maps 132 may include setup position maps, coordinate maps, 3D models, point clouds, for example. As also introduced above, the tracking system 10 may include a course setup module 110 or map data 131 generated thereby. The course setup module 110 may be used to collect tournament or round specific mapping data, e.g., setup position maps, for integration into or use with course maps 132 or other map data 131 used by the tracking system 10. The course setup module 110 may include or incorporate sensor data captured with respect to the location of various tournament or round specific features. Example features include tee locations, hole locations, sensor locations, reference points for calibration of sensors, or center of fairway/turn points to calculate hole locations reports. In one example, the course setup module 110 uses network GPS to identify specific points on the course with centimeter accuracy. In one example, the course setup module 110 may utilize one or more network GPS equipped electronic communication devices 108 that a user may position at specific points corresponding to the features and then interact with the electronic communication device 108 to cause the feature locations, such as coordinates, to be captured.

The sensors may include those described above, such as one or more of radar devices 102, camera devices 104, laser devices 106, electronic communication devices 108, or GPS trackers 109. Example radar devices 102 include ground to air radar. Example camera devices 104 include cameras equipped with computer vision, which may be provided by operations of the sensor data processor 140 or otherwise. Example laser devices 106 include range finders, LIDAR, GPS-enabled range finders/laser technology, or the like. Example electronic communication devices 108 include tablets equipped with digital maps for receipt of user interaction via a display, laser rangefinders, manual coordinate entry fields, interfaces for specification of events, or the like. In one example, electronic communication devices 108 comprise GPS enabled tablets or other devices including digital maps for user interaction. In another example, electronic communication devices 108 comprise GPS enabled tablets or other devices equipped with laser rangefinders allowing users to target an object and the electronic communication device 108 generates a coordinate corresponding to the location of the object. In one embodiment, one or more sensor devices are configured with automated robotics with respect to movement of field of view, object tracking, focusing, or combination thereof.

The tracking system 10 may include a sensor data processor 140 configured to process sensor data for automated player identification. For instance, the sensor data may be used to identify players and keep track of the location of the players on the course, such as holes or hole locations, e.g., zones. The sensor data processor 140 may include an event detection unit 142 configured to automatically create events, such as shot hit, by leveraging sensor data collected by various sensor devices, such as camera devices 104, laser devices 106, e.g., LIDAR, other sensors, such as radar devices 102, together with artificial intelligence. The event detection unit 142 may additionally or alternatively be configured to use the player identification in conjunction with other sensor data, such as radar data that tracks balls from a shot from location to a shot to location, to tie a ball trace to a specific player. Using player identification to identify where the player is, the event detection unit 142 may then tie the shot from location of the trace to the location of the automatically identified player. The event detection unit 142 may additionally or alternatively be configured to identify when a player is near their ball to support creation of automated actions, e.g., the identified player is in position by their ball for a particular shot at a particular location. For instance, the action may include the identified player is in the fairway to hit their second shot. The actions may be repeated for the identified player until the ball is determined or identified to be in the hole. The event detection unit 142 may employ a similar method to identify that a player is standing over another players ball, which, as described in more detail above, may trigger an alert to have someone review the accuracy of the ball location or the player identification. The location of the ball and player in this instance will typically be an area or zone of the course rather than specific coordinates. However, in some embodiments, the location of the ball or player may be determined and provided with respect to course coordinates.

As introduced above, the tracking module 120 may be configured for automated event detection, e.g., shot hit, ball in motion, among others. Leveraging the sensor data, the event detection unit 142 of the sensor data processor 140 may be configured to automatically detect and identify one or more of players, shots hit, ball in motion in the air, ball in motion on the ground, or final resting/end point. Integrated logic of the sensor data processor 140 is executable to enable review and management of the sensor data collected by sensor devices. The logic may include rules to assist in identifying and in some embodiments one or more of reviewing or editing anomalies in the collected sensor data or data derived therefrom, e.g., player identification, events, actions, or the like.

As introduced above, sensor devices may be fixed, mobile, or both. The sensors devices may be setup on a specified geographical area of the course and be calibrated to the area. The calibration may be one or more of integrated with the sensor device, applied to output sensor data separate of the sensor device, or otherwise to calibrate the sensor view. Calibration may be as described above and may include calibrating the sensor view with respect to map data 131, such as a coordinate map. In some embodiments, sensor devices, which may include sensor data collected thereby, may be continuously recalibrated as needed throughout an event based on the map data 131.

Sensor devices, which may include the event detection unit, may be programmed to distinguish between and detect movement from 3D objects, such humans, animals, golf balls, or other environmental objects. In one example, sensor devices may be specifically configured to identify and track movement of a ball or human (player) and transmit its trajectory and location data, which may include coordinates, zone, or other area. Trajectory and location data may include, but is not limited to timestamps, ball in motion in the air, ball in motion on the ground, ball position from landing to resting position in a zone, prediction of ball resting position another zone or detailed zone, or player location on course, range, or otherwise.

Once a player and ball are detected within sensor view, the event detection unit 142 is configured to analyze sensor data about the object to create a related event. In a further example, the analysis includes generating related data that the event detection unit 142 uses to create the relative event. Examples of analyzed sensor data may include player movement, e.g., gait, player recognition, e.g., utilizing clothing color and type of clothing, ball recognition with respect to a specific player, e.g., based on hitting order or last known ball position, ball movement, club movement. These events may trigger updates, notifications, or actions to be taken, such as those described above. Actions, for example, may include transmitting an event to the event database 180 for subsequent coordinate association or the event may be transmitted to the scoring database for dissemination to data clients 182 or other tracking system processes as preliminary, complete, or final, as the case may be. Transmitting the event to the event database 180 may cause a notification to be generated with respect to the availability of a hole event coordinate association by the coordinate processor 156. Events, such as hole events, identification of the event and one or more data elements associated with the event such as a location of the event and timestamp. The location of the event may be a hole, zone, detailed zone, or other area. In one example, the location includes coordinates of the event. The timestamp may correspond to the time the event was detected. In some embodiments, the event may also include data elements such as identification of an identified player associated with the event, a location identifier such as tournament ID or course ID.

In one embodiment, the tracking module 120 also includes a prediction generator 150, which may be similar to that described above. The prediction generator 150 may be configured to leverage sensor data with respect to a shot from location and ball trajectory to support a predicted coordinate identification for a resting position for each captured shot event.

As introduced above, the sensor data may be analyzed to identify coordinates of objects. For instance, using a camera device 104, an area of the course may be monitored for the presence of objects, which will be described as a ball for the present arrangement. When a ball appears within the sensor view of a camera device 104, the coordinates of the ball may be captured as described above and transmitted to the coordinate database 154. Capturing the coordinates may be performed by the coordinate identification unit 144 via analysis of the sensor data. As noted above, sensor devices may be configured with coordinate identification unit 144 logic or otherwise that analyzes the sensor data to identify coordinates, additional aspects, or combination thereof. The sensor data may be calibrated to the sensor view and map data 131 for identification of the coordinates. Thus, in some embodiments, the coordinate identification unit 144 comprises sensor data processors associated with sensor devices. However, in other embodiments, raw sensor data is analyzed by the coordinate identification unit 144 separate of the sensor device to identify coordinates in the raw sensor data, which may be calibrated by the coordinate identification unit previously or at the time of identification.

In one example, when the coordinate identification unit 144 identifies coordinates or receives coordinates, the coordinates are ingested by the sensor data processor 140. In one embodiment, ingestion comprises the coordinate identification unit 144 processing the coordinates. In this example, the coordinates comprise a shot to location. In some embodiments, the coordinates also include a shot from location. The coordinates may further include or be associated with one or more data elements such as a timestamp corresponding to the time the coordinates were captured. The coordinates may be provided in various coordinate systems. For example, in some embodiments, the coordinates comprise geocentric solar magnetospheric (GSM) coordinates. The coordinates may be accompanied by or appended with data elements comprising a device type, e.g., sensor device type, that captured the coordinate. The coordinates may include or be appended with additional data elements, such as a tournament identification, course identification, or other metadata.

Various processing steps may be preformed by the coordinate identification unit 144 with respect to the coordinates and associated data. For example, the aspects of the coordinates may determined, e.g., coordinates are final, or coordinates are approximate. This may include consideration of the sensor device type. In one configuration, the coordinates are translated to a location object with properties based on a mapping in the value of the device type to determine the aspects. In one example, the coordinate identification unit 144 is configured to determine if the coordinates were created by a sensor device without human interaction or by a sensor device via human interaction, e.g., entering the coordinates into an electronic communication device 108, user interaction with a map displayed on an electronic communication device, or targeting the ball with a laser rangefinder associated with an electronic communication device 108. In the above or another example, the coordinate identification unit 144 is configured to determine if the coordinates should be directly associated with a hole event, which is a stroke in this example. In any of the above or another example, the coordinate identification unit 144 may be configured to generate geohash of the shot to location and add it to the location object. If necessary or desirable, the coordinate identification unit 144 may translate the coordinates, e.g., with the coordinate translator 160, to another coordinate system and store the translated coordinates in the location object. Similarly, if the coordinates include a shot from location and it is necessary or desirable, to translate the coordinates to another coordinate system, the coordinates are translated and stored in the location object as the starting location. In any of the above or another example, the coordinate identification unit may identify related locations with respect to the coordinates. This may include, for example, geo-temporally searching the coordinate database 154 for other stored coordinates that exist in the same general area and time as the coordinates. If there are, these coordinates or reference to the coordinates are added to the location object as related locations. The location object may be stored in the coordinate database 154. In one example, a notification is generated that a new coordinate has been stored.

Addition of related locations may be used as a mechanism to tie multiple coordinates together. For instance, in some embodiments, the tracking system 10 does not implement human interaction with respect to identification that a ball at rest originated from a stroke of a certain player. Rather, the tracking module utilizes coordinates from one or more sensors that indicate an ending location and in some instances an ending location. For example, coordinates may be captured by sensor devices comprising radar devices 102, camera devices 103, and human interaction with maps via an electronic communication device 108. Coordinates may also be generated by the prediction generator utilizing sensor data collected by the sensor devices, such as radar devices. Radar is effective at tracking a ball in the air but cannot track a ball once it is on the ground. Cameras are effective at tracking a ball on the ground but can only track what is in their field of view, which is generally much smaller than radar. Some camera devices may also be limited with respect to tracking balls at low speed or when resting. The prediction generator 150 is configured to make an educated prediction as shot to coordinates of a final resting position. In one example, the prediction generator may apply artificial intelligence to the radar data to generate the predicted coordinates. Taking such coordinates as related locations enables tying multiple locations captured by multiple sensor types to get a fuller picture of the ball's travel. For instance, obtaining coordinates for radar, camera images, and predictions, the system gets a shot from and a shot to location ending at impact coordinates from radar, a shot from and a shot to location ending at the actual resting point from camera images but the from or starting location may be outside the field of view of the camera such that the starting point is the first location the ball entered the field of view of the camera, and a shot from and a shot to location ending at a predicted coordinate is obtained from the prediction generator 150. When the coordinates are within a similar location on the course, they will be related and thus the tracking system 10 can track a ball from its “true” starting point to its “true” resting point.

When a notification is received by the coordinate management unit 150 that new coordinates have been stored, the coordinate management unit 150 may determine if the coordinates specify a hole event. If the new coordinates specify a hole event, the coordinates may be deemed manual coordinates and the coordinates may be made a candidate for coordinate association for the hole event. In one example, the coordinate management unit 150 adds a record to a hole event coordinates table with respect to the coordinates, making the coordinates a candidate for coordinate association. In the above or another example, when the coordinate specifies a hole event and the coordinate is made a candidate for association, the coordinate management unit 150 may send a notification to the coordinate processor 156 to run coordinate association for the designated hole event. In some embodiments, if the new coordinates do not specify a hole event, the coordinate management unit 150 is configured to check the event database 158 to search all hole events in the area associated with the coordinates, such as hole events on a specific hole, within a window of time based on the coordinates and the timestamp associated with the coordinates. The coordinate management unit 150 may send a notification to the coordinate processor 156 to run coordinate association for each hole event located. Coordinate association may be performed as described above with respect to FIG. 5 or elsewhere herein.

When a new hole event is received or a notification is received that coordinate associate should be run with respect to a specific hole event, coordinate processor 156 may determine the event source type that captured the event. For example, event source types may include sensor type sensor devices, such as automated, autonomous, or otherwise unmanned, radar devices 102, camera devices 104, laser devices 106. Event source types may include GPS trackers. Event source types may include human involved event entries or manual entries utilizing electronic communication devices. If the event source type corresponds to a sensor device the coordinate processor 156 may search for candidate utilizing various methods. For example, if the hole event does not have a previous hole event for the hole, e.g., the hole event is a tee shot, drop, or other hole event wherein the ball was not hit to the shot from location with respect to the hole event, the coordinate processor 156 determines if the hole event has coordinates set for the hole event yet.

If the coordinate processor 156 determines that the hole event does not have a previous hole event for the hole and the hole event does not have coordinates set yet, the coordinate processor 156 may analyze all coordinates for a time ranged determined from the hole event timestamp for the hole, while coordinates already assigned to a hole event may be discarded. Additionally or alternatively, candidate coordinates may be identified and filtered based on data elements. For instance, coordinates or candidate coordinates may be identified and filtered based on the hole event data elements, e.g., using data elements and distance data. As one example, coordinates or candidate coordinates are filtered that are greater than N yards from the tee if the hole event is a tee shot. As another example, coordinates or candidate coordinates are filtered that are greater than N yards from the pin if the hole event, e.g., stroke, started on the green. As another example, coordinates or candidate coordinates are filtered that are behind or closer to the tee that a drop location for the hole event. Of the remaining candidate coordinates, the coordinate processor 156 may search candidate coordinates for a predicted source type, i.e., a coordinates predicted by the prediction generator 170, and having a starting location corresponding to the hole event location data element. As noted above, predicted coordinates may be based on radar data. Radar data provides a generally known starting point and can be trusted to have a full and reasonably approximate starting coordinate and ending coordinate. If a set of predicted coordinates is located, the remaining candidate coordinates may be filtered based on their distance from the predicted coordinate. The filtered coordinates may then be grouped by coordinate source type (e.g., predicted, camera, radar) and each group is further filtered to select the coordinates in each group closest in time to the hole event. This filtering results in a maximum of one coordinate set per coordinate source type.

In situations where the coordinate processor 156 determines that the hole event does not have a previous hole event for the hole and the hole event does have coordinates set, e.g., in an associated hole event table, the coordinate processor 156 may filter out all candidate coordinates that are of a coordinate type (e.g., predicted, camera, radar, manual) that is already contained in the table. If the table does not include coordinates of the predicted source type, the coordinate processor 156 may search the remaining candidate coordinates for predicted coordinates have a starting location corresponding to the hole event location data element. With the predicted coordinates either being present in the table or located in the search, if not present in the table, the logic above with respect to filtering based on the distance from the predicted shot to location coordinate may be performed to identify a maximum of one set of candidate coordinates for each coordinate source type remaining.

In situations wherein the hole event dose have a previous hole event for the hole, the coordinate processor 156 may utilize the shot to location of the previous hole event to filter coordinates. However, if the previous hole event does not have a shot to location, the coordinate processor 156 falls back to the processing as if there were no previous shot, as described above. The coordinate processor 156 may perform a geo-temporal search as described above to filter candidate coordinates based on the shot to location of the previous shot. However, if all candidate coordinates are filtered out base on the geo-temporal search, the coordinate processor 156 falls back to the processing as if there were no previous shot. The coordinate processor 156 may further filter out candidate coordinates that would result in the ball being N yards further away from the hole. The yards may be based on the shot to location of the previous hole event. The filtered coordinates may then be grouped by coordinate source type (e.g., predicted, camera, radar) and each group is further filtered to select the coordinates in each group closest in time to the hole event. This filtering results in a maximum of one coordinate set per coordinate source type.

In the above processes, the coordinate processor 156 adds all retained candidate coordinates to the hole event coordinates table as candidates for the hole event. To determine which candidate coordinates to be treated as the shot to coordinate, the coordinate processor 156 may call functions to put the strokes, e.g., hole events, for each hole in order and analyze each candidate coordinate and determine which one should be treated as the shot to coordinates. The criteria for determining which candidate should be designated as the active coordinate may be configurable on a per hole basis. However, manual coordinate sensor types entered or captured by personnel with manual entries, laser range finders, or map interaction will generally take hierarchical precedence on shots not from a tee or ending in the hole, in which case “Tee” or “Pin” coordinates take precedence with respect to shot from coordinates and shot to coordinates, respectively. Using the above processing the coordinate processor 156 may associate coordinates with each hole event including both shot to coordinates and shot from coordinates. The paired coordinates and hole events may be transmitted to the scoring database for distribution to data clients 182, use in further tracking system operations, archival purposes, further analysis or updating, or otherwise. In some embodiments, outside of shots from the tee or in the hole, the scoring management unit 160 may determine if the shot to coordinates are derived from the shot from coordinates or if the shot from coordinates is derived from the shot to coordinates.

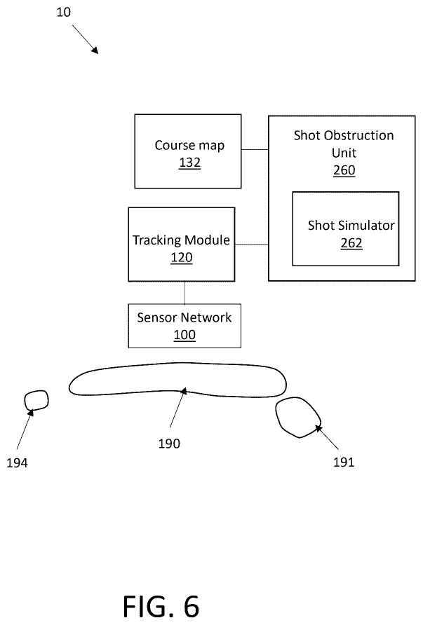

FIG. 6 illustrates an embodiment of the tracking system 10 that includes or incorporate operations of an obstructed shot unit 260. The tracking system 10 may include a tracking module 120 configured to receive tracking data from sensors of a sensor network 100, which may be as described above or elsewhere herein. The obstructed shot unit 260 may be configured to analyze coordinates and determine if a shot from a starting location to a target location with respect to a hole is obstructed.

Obstructed shots may be defined in the obstructed shot unit 260 according to desired criteria. In one example, Obstructed shots may include shots wherein one or more of a player's stance, a player's swing, or the expected flight of the ball is impeded from the starting location to the target location. In a further example, obstructed shots include those wherein the stance, swing, or expected flight is impeded in a way that would force the player to hit a non-typical shot, e.g., slice, hook, lob, or punch out, in order to be able to hit the shot to the target location.

The obstructed shot unit 260 may be configured to receive starting and target locations to apply to the obstructed shot analysis. The starting and target locations may be provided as coordinates relative to the course. Starting coordinates may include predicted final coordinates, actual final coordinates, or both with respect to a previous shots. For example, the obstructed shot unit 260 may be configured to determine if a next shot is obstructed using starting coordinates from a predicted final resting position of the previous shot and output the determination. Additionally or alternatively, the obstructed shot unit may determine if the next shot is obstructed using actual final coordinates from a previous shot. Thus, an initial obstruction determination may be made using predicted final resting position and target coordinates and then a subsequent obstruction determination may be made using actual final resting position and the target coordinates. The subsequent obstruction determination may be used to refine or update the initial obstruction determination. In some embodiments, an obstruction determination using predicted final resting position coordinates, which may be an initial obstruction determination if subsequent determinations are made, may be output before the previous shot lands, comes to rest, or both. In one example, predicted final resting position coordinates from the previous shot may be generated as described above or in U.S. Pat. No. 18,238,234, filed Aug. 25, 2023. Target coordinates may be identified based on the particular course, which may include course play strategy. In some embodiments, target locations may include a particular coordinate location or coordinate area, such as layup areas, zones, such as green, or other areas. Target coordinates corresponding to an area may comprise a set of target coordinates that the obstructed shot unit 260 may utilize for the obstructed shot analysis.

In the example illustrated in FIG. 6, the obstructed shot unit 260 receives a current or starting coordinate for a shot and predicted final resting position and final resting position coordinates from the tracking module 120. In some embodiments, the shot obstruction unit 260 may access the scoring database 162 or receive final resting position coordinates from the scoring database 162. Utilizing the ball coordinates and a course map 132, the obstructed shot unit 260 simulates potential shots from the coordinates to the green. For example, the obstructed shot unit 260 may include a shot simulator 262 configured to simulate shots from starting coordinates to the end coordinate or coordinates.

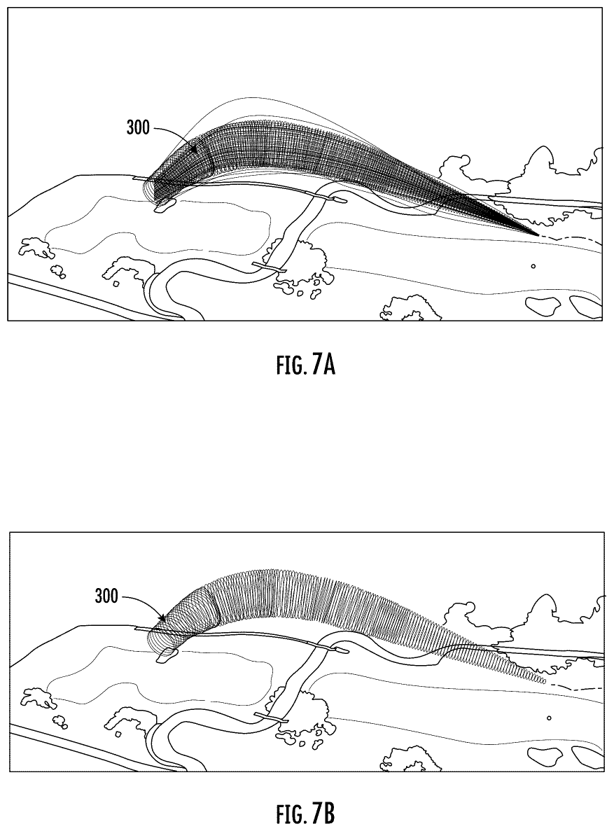

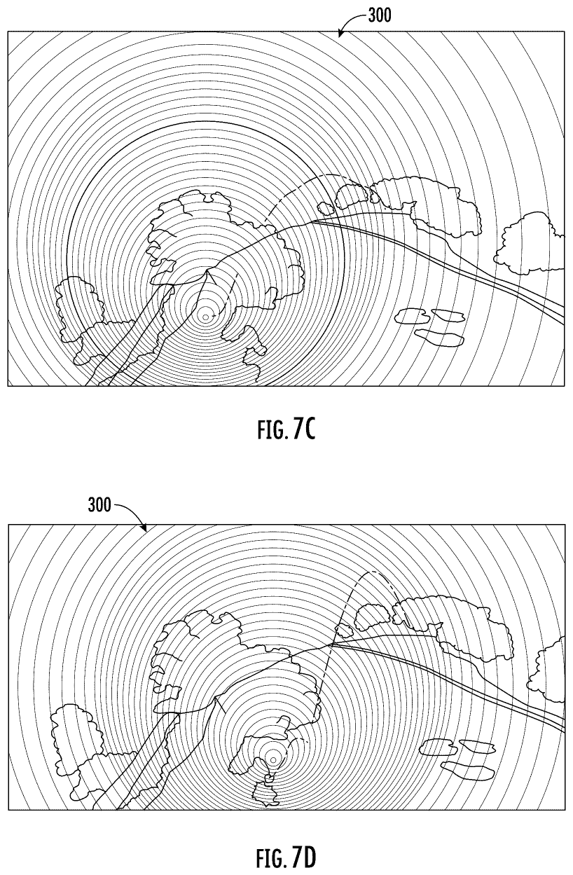

The shot simulator 262 may be configured to utilize ball flight physics to calculate potential flight paths, as depicted in FIG. 7A. For example, the shot simulator 262 may apply a ball flight polynomial. In some examples, parameters of the ball flight may be defined within a range representative of the capabilities of golfers of the player's level. This may include ball speed. The simulations may simulate shots within an available range of lateral exit angles from the location, which may be defined by the lateral extent of the target area, e.g., green, that the ball can exit the starting coordinate and hit the green. In one configuration, an allowable range of fade or draw may be included in the simulations. The simulations may further include simulated shots within an available range of ascent and descent angles, which may be defined in-part by the shot distance. A cone 300 may be created by the cumulative shot simulations from the location and distance of the starting coordinate on the golf course to the target coordinates or area of the target coordinates, such as the green as depicted in FIG. 7B. Analysis of the cone 300 relative to a course map 132 may then be used to determine if the shot is obstructed by examining if there are any obstructions, e.g., a tree, tree branch, or building, are within the inside of the cone 300. The course map 132 may include a 3D representation of the course including trees, sprinkler control boxes, bushes, and other obstructions. In one embodiment, the course map 132 comprises a rich point cloud data set, which may be the same or similar to the 3D point cloud measured using LIDAR or LIDAR and photometry described herein. In one example, the course map 132 comprises a surface model as described herein. In FIG. 7C, the cone 300 is not obstructed, and, thus, the shot is not determined to be obstructed. In FIG. 7D, the cone 300 is obstructed by a tree branch that passes into the inside of the cone 300, and, thus, the obstructed shot unit determines that the shot is obstructed.

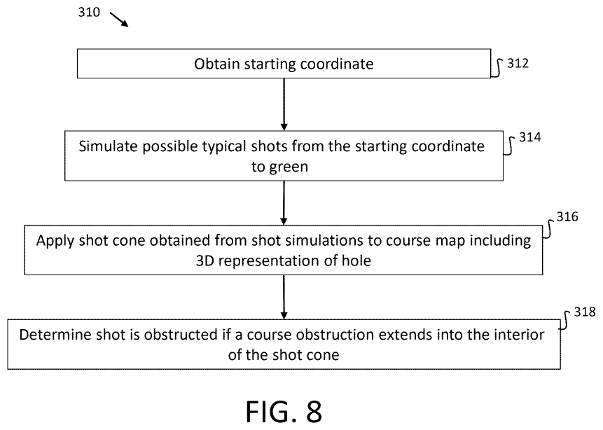

With particular reference to FIG. 8, a method of determining an obstructed shot 310 may include obtaining a starting coordinate 312. The method may also include simulating possible typical shots from the starting coordinate to the green 314. The simulation may be performed as described above. The method may include applying the shot cone 300 obtained from the cumulative shot simulations to a 3D representation of the hole 316. The shot cone 300 positions from the starting coordinate to the green. The method may also include determining the shot is obstructed if an obstruction enters into the interior of the cone 318. In one example, the starting coordinate may be a predicted final resting position coordinates predicted from a previous shot, which may be an actual shot or a predicted shot from an actual previous starting coordinate or a predicted previous final resting position of an actual or predicted previous shot. In another example, the starting coordinate may be a final resting position coordinate determined from sensors such as a camera, laser rangefinder, or LIDAR or personnel interaction with a map, as described herein. In one such example, the starting coordinates are final resting position coordinates associated with the shot via coordinate association. In one embodiment, the shot obstruction unit 260 is configured to perform separate shot obstruction determinations for each predicted final resting position coordinate and final resting position coordinate as measured by a sensor or user interaction with a map. In one configuration, the obstructed shot determination with respect to a predicted coordinate may be preliminarily and made available for data clients 182 and may be updated if the final resting position coordinate determined to be final results in a different obstructed shot determination.

As introduced above, in some embodiments, the shot simulator 262 may additionally or alternatively be configured to determine if a player's swing or stance is or would be obstructed. For instance, the shot simulator 262 may analyze an area around the ball where the player will swing, including obstructions present within a defined 3D space to the right or left of the ball, depending on the handedness of the player, to account for stance and swing components. If the 3D space is obstructed, the shot is determined to be obstructed.

In another of further embodiments, a target location may be other than the green, e.g., a second shot location on a par 5 hole or a layup area on a par 5 hole or following a poor shot, and the obstructed shot unit 260 determines whether the shot is obstructed as described above.

The tracking system 10 may include or utilize one or more databases to store and relay information that traverses the tracking system 10, cache content that traverses the tracking system 10, store data about each of the devices, store coordinates, store hole events, store scoring such as scoring and coordinates corresponding to scoring, and perform any other typical functions of a database. Furthermore, databases may include a processor and memory or be connected to a processor and memory to perform the various operations associated with the databases. The databases described herein may comprise multiple or a single database. Databases may be local or remote. The databases may be distributed. The database may be cloud-based.

While the present disclosure may reference particular applications executed on one or more electronic user devices, it is to be understood that such applications, including any application services, may be provided within a single application, program, or platform or may be divided, virtualized, distributed, or combined into or among any number of executable platforms and resources.

At least a portion of the methodologies and techniques described with respect to the exemplary embodiments may incorporate a machine, such as, but not limited to a computer system or other computing device within which a set of instructions, when executed, may cause the machine to perform any one or more of the methodologies or functions discussed above. The machine may be configured to facilitate various operations conducted by the systems. For example, the machine may be configured to, but is not limited to, assist the systems by providing processing power to assist with processing loads experienced in the systems, by providing storage capacity for storing instructions or data traversing the systems, or by assisting with any other operations conducted by or within the systems. As another example, the computer system may assist with enhancing accuracy coordinates and information gleaned therefrom in a reduced infrastructure environment by incorporating rules such as error and/or warning rules that automatically identify potential discrepancies.

In some embodiments, the machine may operate as a standalone device. In some embodiments, the machine may be connected via a communications network to perform and/or assist with system operations, such as, but not limited to, receiving requests 183, translating coordinates with the coordinate translator 152, calculating distances, analyzing map data 131, simulating shots, predicting coordinates, collecting sensor data, identifying players, detecting balls, transmitting responses, communicating with the various databases, associated system servers, any other system, application, API, program, and/or device, or any combination thereof. The machine may be connected with any component in the systems. In a networked deployment, the machine may operate in the capacity of a server or a client user machine in a server-client user network environment, or as a peer machine in a peer-to-peer (or distributed) network environment, for example. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, the term “machine” shall also be taken to include any collection of machines that individually or jointly execute a set (or multiple sets) of instructions to perform any one or more of the methodologies discussed herein.

The computer system may include a processor (e.g., a central processing unit (CPU), a graphics processing unit (GPU), or both), a main memory and a static memory, which communicate with each other via a bus. The computer system may further include a video display unit, which may be, but is not limited to, a liquid crystal display (LCD), a flat panel, a solid state display, or a cathode ray tube (CRT). The computer system may include an input device, such as, but not limited to, a keyboard, a cursor control device, such as, but not limited to, a mouse, a disk drive unit, a signal generation device, such as, but not limited to, a speaker or remote control, and a network interface device. The disk drive unit may include a machine-readable medium on which is stored one or more sets of instructions, such as, but not limited to, software embodying any one or more of the methodologies or functions described herein, including those methods illustrated above. The instructions may also reside, completely or at least partially, within the main memory, the static memory, or within the processor, or a combination thereof, during execution thereof by the computer system. The main memory and the processor also may constitute machine-readable media.

Dedicated hardware implementations including, but not limited to, application specific integrated circuits, programmable logic arrays and other hardware devices can likewise be constructed to implement the methods described herein. Applications that may include the machine and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine-readable medium containing instructions so that a device, e.g., client device, coordinate translator 152, connected to a communications network, another network, or a combination thereof, can send or receive data, and communicate over the communications network, another network, or a combination thereof, using the instructions. The instructions may further be transmitted or received over the communications network, another network, or a combination thereof, via the network interface device. The term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that causes the machine to perform any one or more of the methodologies of the present disclosure. The terms “machine-readable medium,” “machine-readable device,” or “computer-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. The “machine-readable medium,” “machine-readable device,” or “computer-readable device” may be non-transitory, and, in certain embodiments, may not include a wave or signal per se. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of apparatus and systems that might make use of the structures described herein. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure not be limited to the particular arrangement(s) disclosed as the best mode contemplated for carrying out this invention, but that the invention will include all embodiments and arrangements falling within the scope of the appended claims.

The foregoing is provided for purposes of illustrating, explaining, and describing embodiments of this invention. Modifications and adaptations to these embodiments will be apparent to those skilled in the art and may be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims described below.

What is claimed is:

1. A method of tracking golf play, the method comprising:
receiving a plurality of coordinate sets corresponding to a plurality of shot to locations of golf balls hit by a plurality of players on a hole in a golf event, wherein the plurality of coordinate sets were automatically captured in sensor data of a plurality of sensor device coordinate sources positioned around the hole;
receiving hole events corresponding to strokes of the plurality of players on the hole in the golf event, wherein the hole events were automatically detected in sensor data of a sensor device hole event sources; and
associating, automatically, each of the hole events with one of the plurality of coordinate sets that correspond to the shot to location of the golf ball for the stroke the hole event corresponds to generate detailed scoring data for the plurality of players on the hole in the golf event.

2. The method of claim 1, wherein the plurality of sensor device coordinate sources comprise different types of sensor devices.

3. The method of claim 1, wherein the plurality of sensor device coordinate sources comprise at least a radar device, and wherein the plurality of coordinate sets includes coordinate sets corresponding to predicted shot to locations generated by a prediction generator using trajectory data of the corresponding golf ball.

4. The method of claim 1, wherein the plurality of sensor device coordinate sources comprise one or more radar devices, one or more camera devices, and one or more laser devices.

5. The method of claim 1, wherein the hole events include identification of the player the hole event relates.

6. The method of claim 1, wherein each of the plurality of coordinate sets includes associated data elements comprising a timestamp with respect to time the respective golf ball was identified or predicted to at the shot to location.

7. The method of claim 1, wherein associating each of the hole events with one of the coordinate sets comprises filtering the plurality of coordinate sets to obtain a single coordinate set comprising a “final” shot to coordinate location.

8. The method of claim 1, wherein associating each of the hole events with one of the plurality of coordinate sets includes filtering the plurality of coordinate sets by grouping the plurality of coordinates sets by sensor device coordinate source and retaining a coordinate set for each group that is closest in time to the timestamp of the hole event.

9. The method of claim 1, wherein associating each of the hole events with one of the plurality of coordinate sets comprises executing a candidate coordinate set function on a filtered set of the plurality of coordinate sets to select a single coordinate set for the hole event that corresponds to the shot to location of the golf ball the hole event relates.

10. The method of claim 1, wherein the candidate coordinate set function comprises hierarchy rules with respect to type of sensor device coordinate source.

11. The method of claim 1, wherein associating each of the hole events with one of the plurality of coordinate sets comprises applying one or more of a cascading filter wherein the selection of a coordinate set depends on selection or filtering of another coordinate set, a distance related filter to filter out coordinate sets that are within or outside a distance from a tee or cup of the hole, a geographic filter with respect to geographic data elements associated with the hole events and plurality of coordinate sets, a temporal filter with respect to timestamps data elements associated with the hole events and plurality of coordinate set, or a geo-temporal filter the plurality of coordinate sets.

12. The method of claim 1, wherein associating each of the hole events with one of the plurality of coordinate sets comprises filtering coordinate sets of the plurality of coordinate sets by excluding coordinates that are already associated with a hole event.

13. A tracking system for tracking golf play, the tracking system comprising:
a sensor network comprising a plurality of sensors positioned around a hole of a golf course, the plurality of sensors comprising at least a radar device and a camera device, wherein the radar device is configured for automated tracking of golf balls in flight after being struck by players on the hole, and wherein the camera device is configured to identify players and track the players as they play the hole; and
a tracking module configured to receive radar data generated by the radar device corresponding to a plurality of tracked golf ball in flight after being hit by the players,
wherein the radar data includes timestamps with respect to when the golf balls in flight were tracked and location data at least with respect to an initial ball flight of the tracked golf balls in flight after being struck,
wherein the tracking module configured to receive camera data generated by the camera device corresponding to the players identified and tracked during the play on the hole, wherein the camera data includes timestamps with respect to location data corresponding to locations of the identified tracked players as they played the hole, and
wherein the tracking module is configured to tie the location data corresponding to the locations of the initial ball flights of the tracked balls to the location data corresponding to the locations of the identified tracked players as they played the hole using the respective timestamps to match each of the players to the locations of the initial ball flight of each of their hits when playing the hole.

14. The tracking system of claim 13, wherein the tracking module is configured to automatically generate a hole score for each of the players based on the tracked golf balls in flight matched with the respective identified players.

15. A tracking system for tracking golf play, the tracking system comprising:
a scoring module configured to monitor scoring data with respect to players competing in a golf event that is received into the tracking system, wherein the scoring data is automatically generated by leveraging sensor data with respect to player and ball locations during play that is collected by automated sensor devices positioned around a golf course hosting the golf event.

16. The tracking system of claim 15, wherein the scoring module comprises an application executed by the tracking system that is configured to analyze scoring data, event data, or both stored in a scoring database or event database and identify anomalies in the scoring data, event data, or both.

17. The tracking system of claim 15, wherein the scoring module is configured to communicate with a tracking module to receive event data triggering notifications to the scoring module with respect to player, ball, or object anomalies.

18. The tracking system of claim 15, wherein the scoring module is configured to communicate with a prediction generator, coordinate processor, or both to receive notifications with respect to capturing coordinates.

19. The tracking system of claim 15, wherein the scoring module is configured to provide a notification of an anomaly to electronic communication devices for users of the electronic communication devices to take action and address the anomaly or obtain a coordinate.

20. The tracking system of claim 19, wherein the anomaly relates to anomalous hole event, ball location, player location, ball identification, player identification, or other anomaly.

21. The tracking system of claim 17, wherein scoring data is received from automated analysis of sensor data identifying hole events, personnel interaction with electronic communication devices identifying hole events, or other sources, and wherein as scoring data is being collected, the scoring module is configured to make modifications and add missing data.

22. The tracking system of claim 21, wherein the scoring module is configured to provide access to scoring data to allow users to verify all or a portion of the scoring data, make modifications to existing data, enter missing data based on the user's visual observations, or combination thereof.

23. The tracking system of claim 19, wherein users may indicate ball location on a touch screen of the electronic communication device that displays a digital map of the course.

24. The tracking system of claim 23, wherein users may enter ball coordinates into the electronic communication device determined by identifying the ball location on a grid or other coordinate map overlaying a map of the course.
